(19) United States
(12) Patent Application Publication
(10) Pub. No.: US 2007/0092744 A1
(43) Pub. Date: Apr. 26, 2007

(54) Polymer compositions and films and method of making

(75) Inventors: Carlos Alberto Di Tella, La Gilda (AR); Gerardo Carlos Seidel, Ampere (AR); Hernan Di Tella, Gimenez de Lorca (AR)

Correspondence Address: WILHELM LAW SERVICE, S.C., 100 W LAWRENCE ST, THIRD FLOOR, APPLETON, WI, 54911, US

(73) Assignee: Plasticos Dise S.A., Gue (AR)

(21) Appl. No.: 11/544,422

(22) Filed: Oct. 6, 2006

Related U.S. Application Data
(60) Provisional application No. 60/727,100, filed on Oct. 13, 2005.

(51) Int. Cl. B32B 27/00

(52) U.S. Cl. 428/475.8

(57) ABSTRACT

Polymer compositions, single layer films and multiple layer films, where the composition and/or a layer of a film has base polymer of either amorphous nylon or EVOH, and a modifying semi-crystalline nylon component. Where the base polymer is amorphous nylon, the modifying nylon composition includes a first relatively lower melting temperature nylon, and typically a second relatively higher melting temperature nylon. Where the base polymer is EVOH, the modifying semi-crystalline nylon composition can optionally be defined completely by the relatively lower melting temperature nylon, which has a melting temperature less than 170 degrees C. Blends of disclosed amounts of amorphous nylon or EVOH with the semi-crystalline nylon component can be used to produce films which can be uniaxially oriented or biaxially oriented to provide shrink capacities of at least 28 percent, and up to about 57 percent or more.

### BACKGROUND

This invention relates to polymeric blends, and films, wherein polyamides are used as modifying blend components, in polymeric compositions in which the base polymer is either an amorphous polyamide or an ethylene vinyl alcohol copolymer (EVOH). In particular, the invention relates to nylon blends, and to packaging materials such as nylon non-shrink films and bags, and nylon shrink films and bags. The invention also relates, in particular, to EVOH blends, and to packaging materials such as EVOH non-shrink films and bags, and EVOH shrink films and bags. In either instance, the nylon blends, or the EVOH blends, or both, are suitable for making films for use in packaging food products such as, for example and without limitation, fresh meat, processed meat, and dairy products such as cheese. Further, the nylon blends and the EVOH blends can be used as polymer blends in separate layers in a given multiple layer packaging film.

Nylon is the generic name for a family of polyamide polymers characterized by the presence of the amide group —CONH.

EVOH is the generic name for a family of ethylene copolymers which are characterized by the presence of the hydroxyl group —OH. Commercially available EVOH's generally represent a hydrolyzed state of ethylene vinyl acetate (EVA).

In the food industry, thermoplastic flexible films are used to maintain quality of the contained food product prior to consumption of the food product. The food processing industry continues to seek packaging films which have superior properties relating to maintaining product quality.

Thermoplastic packaging films desirably provide protection at all of the relevant temperatures to which the packaged food product is expected to be exposed. For food items such as, without limitation, primal and subprimal cuts of meat such as beef, pork, and lamb, as well as ground beef, ground pork, ground lamb, and processed meats from such animals, it is known to use coextruded or laminated films which employ, singly or collectively, as desired, layers which employ compositions based on such polymers as nylon, polyester, vinylidene chloride copolymer (PVDC), EVOH, polyolefins such as low density polyethylene (LDPE) or medium density polyethylene (MDPE) or linear low density polyethylene (LLDPE) or very low density polyethylene (VLDPE) or ethylene-vinyl acetate copolymer (EVA) or ionomers, or so-called tie resins such as chemically modified polyolefins.

It is also generally known that selection and/or design of films for use in packaging food products includes consideration of such criteria as film forming processes, film barrier properties, cost, film durability, meeting government safety requirements, film machinability, film sealability, film shrink properties, film strength, and the like.

In general, nylon films are made by processes which include cast extrusion or tubular extrusion. Certain such films can be uniaxially oriented or biaxially oriented. Specific types of nylon such as nylon 6, nylon 66, nylon 6/66, nylon 6/69, nylon 6/12, nylon MXD6, nylon MXD10, and nylon 6I/6T have been made into films. Known advantages of nylon films relative to other film materials in packaging applications include good oxygen barrier characteristics, good flavor barrier characteristics, durability at low temperatures, and thermal stability.

However, nylon resins in general are costly and are poor moisture barriers. It is known to use certain nylon resins in fabricating internal layers in oriented multiple layer films. Moreover, it is known that selection of the specific nylon resins is critical to processability and to achieving desired properties; and it is known that processing nylon resin can be difficult. Polymeric films which contain nylon commonly include one or more additional layers made from any of a wide variety of resins, for example LDPE, MDPE, LLDPE, VLDPE, EVA, EVOH, ionomer, PVDC, copolymers of ethylene and methacrylate, and/or adhesive/tie resins.

Amorphous nylons have been disclosed as being useful in thermoplastic films including multiple layerfilms, including biaxially stretched films. It is known to produce thermoplastic flexible films in which an outer layer comprises a nylon resin composition which includes amorphous nylon as a component thereof. Further, it is known to provide a multiple layer thermoplastic film having optional nylon layers, such as layers containing copolymers of nylon 6 and nylon 12, generally known as nylon 6/12, which copolymers are sold by EMS-Chemie AG, Switzerland under the names Grilon CF 6S®, Grilon CR 9®, and Grilon CF 7®. It is also known to use, for food packaging, a nylon composition which includes an amorphous nylon such as those sold under the brand names Novamid X21® by Mitsubishi Chemical Industries, Japan, Grivory G 21® by EMS, Switzerland, Grivory FE 4494® by EMS, Switzerland, and Grivory FE 4495®) by EMS, Switzerland, and Selar PA 3426®) by DuPont, USA.

Oriented nylon films are known in the packaging industry for their toughness, puncture resistance, and a moderate level of oxygen barrier. In particular, biaxial orientation is known to generally improve the strength of a nylon layer.

The barrier properties of oriented nylon films generally provide greater resistance to oxygen permeability as the level of absorbed moisture in the nylon layer decreases. By corollary, as moisture content in the nylon layer increases, the oxygen barrier properties of the oriented nylon layer generally deteriorate. Thus, when a nylon layer is to be used or stored under humid or other moist conditions, it is desirable to protect the nylon layer from the moisture e.g. by placement of the nylon between protective polymeric layers which have relatively lower permeability to moisture, in order to keep the nylon dry or to at least delay the arrival of moisture at the nylon layer.

It is in some instances desirable to employ amorphous nylon as the base nylon resin, in order to benefit from the moisture insensitivity features inherent to amorphous nylon. However, orientation of coextruded multiple layer blown films, which contain a layer which is substantially 100% amorphous nylon, is difficult due to processing constraints. Particularly, the orientation temperature of especially the amorphous nylon is higher than the orientation temperature range of the typical olefinic-type polymers which are desirably joined with the amorphous nylon layer in a multiple layer film.

In some packaging applications, it is desirable that at least one of the layers, typically a surface layer of the film, have good heat seal properties. Polymers which have both good heat sealability, and which are generally impermeable to moisture include various polyethylenes, ethylene copolymers, and ionomers. Nylon layers and/or EVOH layers are typically, but not always, used in combination with heat sealable and moisture resistant layers. Additional layers can be added to the film structure in order to achieve specific objectives regarding performance of the packaging structure.

The polymer choices for film layers which provide high levels of barrier to both moisture vapor transmission and oxygen transmission are generally limited to PVDC polymers. However, PVDC can be a less-desired oxygen barrier material for certain films, both because of film properties and because of processing constraints. Where PVDC use is contra-indicated, nylon and/or EVOH can typically be employed for the oxygen barrier properties, commonly in multiple layer films where other layers are employed to protect the oxygen barrier layer or layers from moisture. Thus, a good oxygen barrier material, such as a nylon composition or an EVOH composition, is typically protected from moisture by employing an intervening layer of a material, located between the oxygen barrier layer and the moisture source, which intervening layer operates as a moisture barrier. Where excellence in oxygen barrier is a primary objective, EVOH is preferred.

Nylon is known for use as the core portion of a film being coextruded or coated with sealant resins such as LDPE, EVA, ionomers, copolymers of ethylene and methacrylate, and the like. EVOH is another oxygen barrier material, and both EVOH and nylon can advantageously be used in the same film. The nylon layer acts as an oxygen and flavor barrier for such film uses, and may provide a toughness increment as well. The EVOH layer performs the usual function, largely in the capacity of an excellent oxygen barrier.

In some implementations, nylon can be used on one or both opposing sides of a layer of EVOH, e.g. as a 3-layer structure of

/nylon/EVOH/nylon/

which provides excellent oxygen barrier properties. The nylon layers can be outer layers of the film, or internal layers of the film. Where both EVOH and nylon are used in the same film, and especially where both the EVOH and the nylon are to be protected from moisture, both the nylon and the EVOH can provide significant contributions to the oxygen barrier feature of the film.

In a typical known process for producing multiple layer films containing oriented nylon, the film is first extruded and quenched, and is subsequently reheated to a softened state which is generally below the melting point temperatures of the respective polymers, and the softened film is stretched.

Conventional nylon resins typically crystallize very rapidly when cooling during the film-forming melt-extrusion step, and have melting points well in excess of typically adjacent olefinic e.g. polyethylene layers. Due to these temperature differences, and because nylon and polyethylene tend to have different stretching characteristics, a nylon layer in a conventional multiple layer film may advantageously be oriented separately, and in advance of its combination with the adjacent e.g. olefinic layers. The combination of the oriented nylon layer with the adjacent layers is then accomplished using a conventional but relatively more expensive lamination process. Such lamination process can require use of an adhesive layer, such as a layer of a polyurethane type adhesive, applied with an adhesive laminator.

Where a nylon layer is combined with a layer of EVOH, optionally with other layers of olefinic e.g. ethylene-based, polymers and/or copolymers, the known difficulties of orienting EVOH, and the stiffness, and limited amount of stretchability of known EVOH compositions, further complicate the issue of identifying acceptable processing conditions by which the film can be oriented.

Known multiple layer oriented nylon films, which require stretchability of the nylon layer, and which do not employ substantial fractions of amorphous nylons, e.g. no more than 30 percent by weight amorphous nylon, are known to have inferior stretch capacities.

Oxygen transmission rates of films which employ EVOH are desirably less than 30 cc/m² 24 hours/1 Atm, while oxygen transmission rates of no more than 15 cc/m² 24 hours/1 Atm are typical of such films. Even lower oxygen transmission rates are commonly desired where reasonably achievable in a packaging film.

Oxygen barrier level provided by an EVOH layer is affected by the relative mole percent ethylene compared to the mole percent carboxyl/alcohol units in the EVOH. Relatively higher levels of alcohol, and corresponding relatively lower levels of ethylene, provide relatively higher levels of oxygen barrier. Conversely, relatively higher levels of ethylene moieties and accompanying lower levels of alcohol moieties, are characterized by a polymer which is relatively less brittle, and relatively more easily processed, albeit with lower levels of oxygen barrier.

The EVOH layer is typically located inwardly of the outer layers of the film. The composition of at least one intervening layer is typically selected to protect the EVOH layer from especially moisture, and/or physical abuse.

In general, films which contain a layer of EVOH and/or a layer of nylon are made by processes which include cast extrusion or tubular extrusion. In cast extrusion, a melt-extruded flat-sheet film is cooled and solidified by casting the extrudate onto a controlled-temperature chill roll. In tubular extrusion, a melt-extruded tube is cooled and solidified by a flow of e.g. ambient air directed against the melted tube which emerges from the extrusion die. The melted tubular extrudate can, in the alternative, be cooled, and solidified, by directing the tubular extrudate into a controlled-temperature water reservoir, in a process known generally as a “water quench” process.

In general, extrusion processes wherein the extrudate is quickly cooled to below the melting temperature of the film, such as cast extrusion or water quench extrusion, produce relatively more amorphous polymeric structures which are relatively softer when re-heated in a subsequent orientation process. By contrast, extrusion processes wherein the extrudate is cooled more slowly, such as air-cooled tubular extrusion, produce relatively more crystalline polymeric structures which are relatively harder and more stiff when heated in a subsequent orientation process.

EVOH-containing films are known for use in food packaging in many of the same applications where nylon-containing films are used. Thus, there can be mentioned, without limitation, such uses as the packaging of primal and subprimal cuts of meat such as beef, pork, and lamb, as well as ground beef, ground pork, ground lamb, and processed meats such as hot dogs, ham, bacon, salami and sausage.

EVOH-containing films are known for use in vacuum packaging of fresh meat. However, to the extent substantial shrinkage of the film about the contained product is required, e.g. greater than about 25 percent shrink, known EVOH films and EVOH compositions are commonly unable to satisfy such high degree of shrink. Rather, known EVOH films typically are limited to about 20-30 percent shrink or less. Thus, where greater than 20-30 percent film shrink is needed, the excellent level of oxygen barrier properties of EVOH polymer are simply not conventionally available to the e.g. meat packager.

The excellent oxygen barrier property provided by EVOH, when the EVOH is kept dry, is well known. It is also well known that, similar to nylon, the oxygen barrier provided by EVOH decreases substantially with increase in moisture. Thus, as with nylon, the EVOH is advantageously protected from moisture in order that the benefits of its excellent oxygen barrier properties be obtained. Accordingly, it is known to provide one or more barrier layers on each side of the EVOH layer, to protect the EVOH layer from moisture.

EVOH is also brittle. Thus, it is known to provide physical support to the EVOH layer on one or both sides of the EVOH layer, with more resilient layers such as nylon layers, whereby the support layers absorb a portion of any stresses imposed on the film. This sharing of stresses, among other things, enhances the capability of the EVOH layer to tolerate the repeated flexing which is characteristically experienced in flexible film packaging implementations.

Packaging films are commonly oriented, e.g. biaxially oriented, in order to achieve enhanced properties. Such property enhancements typically relate (i) to strength, toughness, or clarity, and/or (ii) to creating a shrink capability in the film.

Shrink films are used in packaging implementations where it is desired to evacuate all, or nearly all, gases from the package, and/or where it is otherwise desired to have the packaging material shrink into intimate contact with substantially the entire surface of the contained product.

Thus, shrink films are used in, for example and without limitation, packaging of non-cook-in or cook-in meat products. Such meat products include smaller retail cuts, as well as larger meat cuts such as halves, quarters, and the like, of meat animal carcasses. Especially in the case of animal carcasses, the overall shrink capacity of the film, at e.g. 90 degrees C., 2 sec, should be at least 30 percent, optionally at least about 40 percent, and advantageously at least about 50 percent, of the starting, biaxially stretched dimensions of the film. The higher the shrink amount, the better. Advantageously, the market also wants low oxygen barrier, such as no more than 10-15 cc/m²24 hrs 1 ATM.

The biaxially stretched film must be able to provide such shrink amount, including shrinking against the inner surfaces of e.g. the chest cavity of the animal carcass, without penetration of, breach of, or otherwise compromising the integrity of, the film or any layer of the film. Particularly, the integrity of any oxygen barrier layer, and of any moisture barrier layer being relied on to protect any oxygen barrier layer, must remain intact after completion of the shrink process, in order to preserve the benefits of the oxygen barrier properties of the film.

Biaxial orientation of conventional multiple layer films containing EVOH layers is generally limited to a stretch amount which will produce a shrink of about 20-30 percent in a given direction. While so-called “stretchable” grades of EVOH have become available, the ability to stretch EVOH-containing films is still generally limited to stretching which provides no more than about 30 percent shrink in any one direction, commonly no more than about 25 percent shrink in any one direction. Performance data from Kuraray regarding their EVAL® resins teaches, according to Kuraray's published Performance Map, maximum orientation ratio of about 21 percent for Kuraray's most stretchable grade EVOH.

Considering the degree of overall shrink required for certain implementations as illustrated above, at up to about 50 percent shrink at 90 degrees C. in e.g. the transverse direction, and considering the limitations of known EVOH materials, films and processes, which generally provide only about 20 percent to about 30 percent shrink, conventional EVOH technology is not able to satisfy the requirements of the marketplace, whereby conventional EVOH, even so-called stretchable grades of EVOH, is believed to not be capable of providing an oxygen barrier layer in shrink films which require greater than 30 percent shrink.

In light of the above-discussed limitations, there currently exists a search for films which can provide improved barrier properties such as high oxygen barrier and high flavor barrier, as well as for such films which have high levels of shrink capacity. There is also a search for oriented films which contain one or more layers of nylon and/or EVOH, and which can be produced by a coextrusion process. Namely, production of multiple layer films by coextrusion is generally more economical than use of lamination methods. There is still further a search for films which include one or more layers which contain amorphous nylon.

The present invention provides improved nylon resin blend compositions and improved EVOH resin blend compositions, and films derived from such nylon resin blend compositions and such EVOH resin blend compositions, based on a common general polymer blending concept. Such blend compositions, and films, including oriented such films, attenuate and/or solve selected ones of the above-described limitations of films which contain nylon and/or EVOH layers.

It is not necessary that each and every issue mentioned above be overcome by all embodiments of the invention. It is not necessary that each and every issue mentioned above be overcome by any one embodiment of the invention. It is sufficient that a given embodiment of the invention may be advantageously employed when compared to the prior art.

### SUMMARY OF THE INVENTION

According to the present invention, novel resin blend compositions comprise base resin of either EVOH or amorphous polyamide, and in addition comprise a modifying semi-crystalline polyamide component.

Where the base resin is amorphous nylon, the modifying semi-crystalline nylon composition includes a first relatively lower melting temperature semi-crystalline nylon, and a second relatively higher melting temperature semi-crystalline nylon. The relatively lower melting temperature first semi-crystalline nylon has a melting temperature of less than 170 degrees C., typically 160 degrees C. or less, and generally less than about 145 degrees C. Exemplary such lower melting temperature first semi-crystalline nylons are nylon 6/69's and some of the nylon 6/12's.

The second semi-crystalline nylon has a relatively higher melting temperature, above 145 degrees C., commonly above 180 degrees C., and above the melting temperature of the first semi-crystalline nylon. A typical such relatively higher melting temperature nylon is nylon 6/66, having a melting temperature of about 195 degrees C.

Where the base resin is EVOH, the modifying semi-crystalline nylon composition can be defined completely by the relatively lower melting temperature semi-crystalline nylon composition which has a melting temperature of less than 170 degrees C., typically 160 degrees C. or less, and generally less than about 145 degrees C. An exemplary such modifying relatively lower melting temperature nylon composition is nylon 6/69 having a melting temperature of about 134 degrees C. Another exemplary relatively lower melting temperature modifying nylon composition is nylon 6/12 having a melting temperature of about 130 degrees C. up to e.g. about 155 degrees C.

In the alternative, the overall modifying semi-crystalline nylon composition can include the second relatively higher melting temperature semi-crystalline nylon composition.

The blends newly disclosed herein can be utilized to form novel thermoplastic flexible films having one or more layers. These inventive films are generally susceptible to biaxial or uniaxial orientation. These inventive films possess excellent properties related to stretchability, clarity, gas barrier, and shrinkability. For example, the blends of the invention form films which are relatively easy to biaxially orient compared to films wherein the composition of the given film is substantially defined by a single one of the individual blend components such as an EVOH component alone, or an amorphous nylon component alone.

It has been discovered that blending a relatively lower melting temperature semi-crystalline nylon with an amorphous nylon such as nylon 6I/6T, when supplemented with a nylon having the above-recited relatively higher melting temperature, produces a film which can be successfully uniaxially oriented or biaxially oriented. For example, biaxially orientating a film layer formed of amorphous nylon alone, in a multiple layer film with ethylenic polymers in other layers, is difficult, and attempts at such biaxial orientation may be unsuccessful.

However, an exemplary blend of the invention which comprises about 40 percent by weight amorphous nylon, along with nylon 6/69 and/or nylon 6/12, and nylon 6/66 in the blend composition, can be uniaxially oriented or biaxially oriented according to the present invention. The present invention shows successful biaxial orientation of films having a nylon-based layer, wherein the nylon layer comprises a blend of semi-crystalline nylon copolymer or terpolymer, such as up to about 50 percent by weight nylon 6/69 and/or nylon 6/12, the blend having a melting temperature of less than about 145 degrees C., with amorphous nylon, thereby to make a 3-component, or more, nylon blend. Such oriented films have excellent optical and oxygen barrier properties.

According to the present invention, the entire multiple layer film is biaxially stretched without the necessity for the combined actions of (i) separately biaxially stretching any nylon layer or any EVOH layer independent of the stretching of the other respective non-nylon and non-EVOH layers, and (ii) laminating the separately-stretched layers to each other.

Unexpectedly, adding the recited semi-crystalline nylon materials, such as nylon 6/69 and/or the relatively lower melting temperature nylon 6/12, to the amorphous nylon base resin, or to the EVOH base resin, in the recited relative amounts, forms a blend which can be processed to make a shrinkable film. The shrink film exhibits high gloss, low haze, and good shrinkage values at temperatures of e.g. 90 degrees C., 2 sec. Addition of the recited semi-crystalline nylons to amorphous nylon, or to EVOH, according to the present invention results in improvements in one or more of such properties as operability of the orientation process, stretch consistency, flexibility, the extent of orientation which is possible, shrink percentage after orientation, reduced brittleness, or the like.

Advantageously, certain blends of the present invention can be employed to form uniaxially or biaxially oriented single layer films or multiple layer films.

The compositions of the invention can also be fabricated for use in the form of unoriented films.

As used herein, reference to a “base resin”, to a “nylon-based layer” orto an “EVOH-based layer”, when addressing a layer which contains nylon or EVOH, refers to the recited polymer family, and wherein the recited polymer family provides properties which generally control the predominant gas barrier characteristics, e.g., oxygen barrier and/or flavor barrier properties, of a film made with such resin or layer.

The EVOH is preferably saponified/ hydrolyzed to at least about 90 percent to achieve the desired level of oxygen barrier. More preferably, the EVOH is saponified/ hydrolyzed to at least about 95 percent, still more preferably at least about 99 percent. Generally, the greater the degree of saponification, the greater the degree to which the potential oxygen barrier of the polymer can be realized.

Typically, EVOH useful in the invention comprises about 25 mole percent to about 50 mole percent ethylene; optionally about 27 mole percent to about 48 mole percent ethylene.

When nylon is the base resin for a blend layer of the invention, a broad expression of the compositions of the invention is about 15 percent by weight to about 65 percent by weight amorphous nylon and correspondingly about 85 percent to weight to about 35 percent by weight semi-crystalline nylon, wherein about 5 percent by weight to about 50 percent by weight of the composition is the relatively lower melting temperature nylon and about 10 percent by weight to about 80 percent by weight, optionally about 10 percent by weight to about 55 percent by weight, of the composition is the relatively higher melting temperature nylon, and where the relatively higher melting temperature nylon can be represented at least in part by nylon terpolymer.

Where the nylon layer composition is about 15 percent by weight to about 65 percent by weight amorphous nylon, the relatively lower melting temperature nylon can be about 5 percent by weight to about 35 percent by weight, optionally about 18 percent by weight to about 50 percent by weight of the overall composition, and the relatively higher melting temperature nylon can be greater than 30 percent by weight to about 55 percent by weight of the overall composition.

In some embodiments, the nylon layer composition is about 15 percent by weight to about 55 percent by weight amorphous nylon, about 18 percent by weight to about 35 percent by weight of the relatively lower melting temperature nylon, and about 30 percent by weight to about 55 percent by weight of the relatively higher melting temperature nylon, and where the relatively higher melting temperature nylon can be represented at least in part by nylon terpolymer.

In some embodiments, the nylon layer composition is about 15 percent by weight to about 45 percent by weight amorphous nylon, about 5 percent by weight to about 35 percent by weight relatively lower melting temperature nylon, and about 30 percent by weight to about 55 percent by weight relatively higher melting temperature nylon.

In some embodiments, the nylon layer composition is about 20 percent by weight to about 50 percent by weight amorphous nylon, about 10 percent by weight to about 30 percent by weight relatively lower melting temperature nylon, and about 40 percent by weight to about 65 percent by weight relatively higher melting temperature nylon, and where the relatively higher melting temperature nylon is optionally represented at least in part by nylon terpolymer.

In some embodiments, the nylon layer composition is about 20 percent by weight to about 55 percent by weight amorphous nylon and about 80 percent by weight to about 45 percent by weight semi-crystalline nylon. In terms of the overall layer composition, about 10 percent by weight to about 30 percent by weight, optionally about 18 percent by weight to about 30 percent by weight is the lower melting temperature nylon, and about 30 percent by weight to about 55 percent by weight, optionally about 40 percent by weight to about 55 percent by weight, is the relatively higher melting temperature nylon.

In some embodiments, the nylon layer composition is about 25 percent by weight to about 40 percent by weight amorphous nylon, about 10 percent by weight to about 20 percent by weight, optionally about 12 percent by weight to about 20 percent by weight lower melting temperature nylon, and about 45 percent by weight to about 55 percent by weight relatively higher melting temperature nylon.

A second broad expression of the nylon blend composition is greater than 30 percent by weight to about 65 percent by weight amorphous nylon and correspondingly about 35 percent by weight to less than 70 percent by weight of the semi-crystalline nylon.

In some embodiments, the nylon layer composition is about 30 percent by weight to about 40 percent by weight amorphous nylon and about 70 percent by weight to about 60 percent by weight semi-crystalline nylon. In terms of the overall layer composition, about 10 percent by weight to about 20 percent by weight, optionally about 10 percent by weight to about 25 percent by weight, optionally about 10 percent by weight to about 30 percent by weight, optionally about 18 percent by weight to about 30 percent by weight is the relatively lower melting temperature nylon, and about 40 percent by weight to about 55 percent by weight, optionally about 45 percent by weight to about 55 percent by weight, optionally about 50 percent by weight to about 65 percent by weight is the relatively higher melting temperature nylon, optionally including nylon terpolymer in the relatively higher melting temperature nylon.

In some embodiments, the nylon layer composition is greater than 30 percent by weight to about 40 percent by weight amorphous nylon, about 10 percent by weight to about 25 percent by weight relatively lower melting temperature nylon, and about 40 percent by weight to about 55 percent by weight relatively higher melting temperature nylon.

In some embodiments, the nylon layer composition is greater than 30 percent by weight to about 55 percent by weight amorphous nylon, about 10 percent by weight to about 25 percent by weight relatively lower melting temperature nylon , and about 30 percent by weight to about 55 percent by weight relatively higher melting temperature nylon.

Where EVOH is the base resin for a blend layer of the invention, a broad expression of such compositions of the invention is about 40 percent by weight to about 98 percent by weight EVOH and about 60 percent by weight to about 2 percent by weight semi-crystalline nylon, and wherein a substantial fraction, e.g. at least about 50 percent by weight, of the semi-crystalline nylon component is relatively lower melting temperature nylon.

In some embodiments, the EVOH layer composition comprises about 5 percent by weight to about 50 percent by weight, optionally about 5 percent by weight to about 40 percent by weight, optionally about 5 percent by weight to about 35 percent by weight, optionally about 5 percent by weight to about 30 percent by weight, semi-crystalline nylon having effective melting temperature of less than 170 degrees C., optionally nylon 6/69 and/or nylon 6/12.

In some embodiments, the EVOH layer composition comprises about 10 percent by weight to about 40 percent by weight, optionally about 10 percent by weight to about 30 percent by weight, optionally about 10 percent by weight to about 20 percent by weight semi-crystalline nylon having effective melting temperature of less than 170 degrees C., optionally nylon 6/69 and/or nylon 6/12.

In some embodiments, the EVOH layer composition comprises about 15 percent by weight to about 35 percent by weight semi-crystalline nylon having effective melting temperature of less than 170 degrees C., optionally nylon 6/69 and/or nylon 6/12.

In some embodiments, the EVOH layer composition comprises about 20 percent by weight to about 40 percent by weight semi-crystalline nylon having effective melting temperature of less than 170 degrees C., optionally about 20 percent by weight to about 25 percent by weight nylon 6/69 and/or nylon 6/12 having effective melting temperature of less than 170 degrees C.

In some embodiments, the EVOH layer composition comprises about 30 percent by weight to about 40 percent by weight semi-crystalline nylon having effective melting temperature of less than 170 degrees C., optionally nylon 6/69 and/or nylon 6/12.

Oriented films of the invention, both single layer films and multiple layer films typically have shrink capacities greater than 28 percent, optionally at least 40 percent, optionally at least 44 percent, optionally at least 50 percent, in at least one of the machine direction and the cross-machine direction, e.g. transverse direction.

In some embodiments, the films have shrink capacities of greater than 28 percent and up to about 55 percent, and greater.

In some embodiments, the films have shrink capacities of greater than 35 percent and at least 3 percentage points greater than the shrink capacities of corresponding films but which have not been modified according to the invention.

### BRIEF DESCRIPTION OF THE DRAWINGS

FIG. 1 illustrates a cross-section of a single-layer nylon-based film of the invention containing amorphous nylon modified with a semi-crystalline nylon composition.

FIG. 2 illustrates a cross-section of a single-layer EVOH-based film of the invention containing EVOH, either stretchable grade EVOH or regular grade EVOH, modified with a semi-crystalline nylon composition.

FIG. 3 illustrates a cross-section of a 2-layer film of the invention having a first nylon-based layer of nylon and a second EVOH-based layer, wherein one or both of the nylon layer and the EVOH layer comprises a semi-crystalline nylon composition.

FIG. 4 illustrates a cross-section of a 3-layer film of the invention having a first EVOH-based layer, and second and third nylon-based layers on opposing surfaces of the EVOH-based layer, and wherein at least one of the first, second, and third layers comprises a semi-crystalline nylon composition.

FIG. 5 illustrates a cross-section of a 5-layer film of the invention wherein nylon-based layers are disposed on opposing sides of an EVOH-based layer, and olefin-based layers form the outer layers of the film, outwardly of the nylon-based layers, and wherein at least the EVOH-based layer, or one of the nylon-based layers, comprises a semi-crystalline nylon composition.

FIG. 6 illustrates a cross-section of a 7-layer film of the invention wherein nylon-based layers are disposed on opposing sides of an EVOH-based layer, wherein olefin-based layers form the outer layers of the film, outwardly of the nylon-based layers, wherein tie layers are disposed between the outer layers and the nylon-based layers, and wherein at least the EVOH-based layer, or one of the nylon-based layers, comprises a semi-crystalline nylon composition.

FIG. 7 illustrates a cross-section of a 9-layer film of the invention wherein a tie layer is disposed between first and second interior EVOH-based layers, a first nylon layer is disposed between the first EVOH layer and a first polyolefin surface layer and a second nylon layer is disposed between the second EVOH layer and a second and opposing polyolefin surface layer, and second and third tie layers are disposed between the first and second nylon layers and the respective adjacent polyolefin surface layers, and wherein at least one of the EVOH-based layers, or one of the nylon-based layers, comprises a blend composition of the invention.

The invention is not limited in its application to the details of construction, or to the arrangement of the components set forth in the following description or illustrated in the drawings. The invention is capable of other embodiments or of being practiced or carried out in various other ways. Also, it is to be understood that the terminology and phraseology employed herein is for purpose of description and illustration and should not be regarded as limiting. Like reference numerals are used to indicate like components.

### DETAILED DESCRIPTION OF THE ILUSTRATED EMBODIMENTS

This invention utilizes amorphous nylon copolymer as a first component of a novel nylon-based polymer composition used to produce novel single and multiple layer films. The term “amorphous” as used herein denotes an absence of a regular three-dimensional arrangement of molecules or subunits of molecules extending over distances which are large relative to atomic dimensions. However, regularity of structure may exist on a local scale, as discussed at “Amorphous Polymers,” Encyclopedia of Polymer Science and Engineering, 2nd Ed., pp. 789-842 (J. Wiley & Sons, Inc. 1985). In particular, the term “amorphous nylon” as used with respect to the present invention refers to a material which has no measurable melting point (less than 0.5 cal/g) or no heat of fusion as measured by differential scanning calorimetry (DSC) using ASTM D3418-03.

Exemplary amorphous nylon copolymers useful in the invention include hexamethyleneisophthalamide-hexamethylene terephthalamide copolymer, also referred to as nylon 6I/6T. An exemplary component of the invention is hexamethyleneisothalamide-hexamethylene terephthalamide copolymer which has from about 65 percent to about 80 percent of its polymer units derived from hexamethyleneisophthalamide. Other isophthalate-terephthalate moiety ratios are also contemplated.

Exemplary of the amorphous nylon copolymer component is a commercially available nylon 6I/6T sold by the DuPont Company of Wilmington, Del., U.S.A. under the trademarked designation Selar PA 3426®.

Selar PA 3426® is further characterized by DuPont Company as amorphous nylon having superior transparency, good barrier properties to gases such as oxygen, solvents, and essential oils.

Another 6I/6T amorphous polyamide which has been found useful in the invention is known as Grivory G21®, available from EMS Chemie, Switzerland. Still other amorphous polyamides which have been found useful are Grivory FE 4494® and Grivory FE 4495®), also available from EMS Chemie. The above-mentioned amorphous nylon polymers have the following properties:

| | G21 | FE4494 | FE4495 | SELAR PA 3426 |
|---|---|---|---|---|
| Density | 1.18 | 1.15 | 1.15 | 1.19 |
| Glass Transition Temp | 125° C. | 100° C. | 80° C. | 127° C. |

Amorphous nylon copolymer used in the present invention can be manufactured by e.g. the condensation of hexamethylenediamine, terephthalic acid, and isophthalic acid, to obtain 6I/6T copolymer, according to known processes.

Exemplary relatively lower melting temperature polyamides, useful as the second component in forming blends and films of the present invention, are copolyamides having melting temperatures of less than 170 degrees C., typically 160 degrees C. or less, and generally less than about 140 degrees C. An exemplary such second-component modifying nylon is nylon 6/69 having a melting temperature of about 134 degrees C. Another exemplary second-component modifying nylon is nylon 6/12 having a melting temperature of about 130 degrees C. up to about 155 degrees C.

Suitable relatively higher melting temperature polyamides, useful as the third component in forming blends and films of the present invention, are polyamides having melting temperatures of at least 145 degrees C. Preferred copolyamides melt at temperatures within a range of from about 145 degrees C. to about 215 degrees C., commonly above 170 degrees C. A typical such relatively higher melting temperature nylon is nylon 6/66, having a melting temperature of about 195 degrees C.

While choosing to not be bound by theory, the inventors herein contemplate that the role of the relatively lower melting temperature semi-crystalline nylon is to facilitate orientation of the film, where the film is to be oriented, while the role of the relatively higher melting temperature semi-crystalline nylon is to facilitate maintaining integrity of the film structure at typical processing temperatures. The combination of the relatively lower melting temperature semi-crystalline nylon and the relatively higher melting temperature semi-crystalline nylon, with amorphous nylon, enables fabrication of a film layer having a substantial fraction of amorphous nylon, while maintaining desirable film fabrication capabilities, film stability under typical processing conditions, stretch capacity in the desired amounts, if any is desired for the contemplated end use of the film, and shrink capacity in the desired amounts. The inventors further contemplate that the lower melting temperature semi-crystalline nylon facilitates flow of the amorphous nylon during stretch and shrink activities.

Accordingly, combinations of the relatively lower melting temperature semi-crystalline nylon and the relatively higher melting temperature semi-crystalline nylon have been found to form useful blends with amorphous nylons, which blends can be processed into films, including oriented films.

There can be mentioned, as exemplary of the relatively higher melting temperature semi-crystalline nylons, for example and without limitation, homopolymer nylons such as nylon 6, nylon 66, nylon 11 and nylon 12, copolymer nylons such as nylon 6/66, nylon 6/12, nylon 66/MXD10, and nylon 6/10, and terpolymer nylons such as nylon 6/66/12, nylon 66/610/MXD6, and nylon 66/69/6I. Mixtures of one or more of homopolymer nylons, copolymer nylons, and terpolymer nylons are also contemplated.

Exemplary third component copolyamides are nylon 6/12 and nylon 6/66, and related nylon terpolymers having suitable melting temperatures. Nylon 6/12 and nylon 6/66 are commercially available, as are related terpolymers. For example a nylon 6/12 copolyamide which melts at about 200 degrees C. is commercially available under the trademark Grilon® CR 9 from EMS-Chemie AG, Switzerland.

Mixtures of polyamides, copolyamides, and/or terpolyamides can be usefully employed as the relatively higher melting temperature semi-crystalline nylon component in the present invention so long as the employed mixture has an effective melting temperature within the recited temperature range. For example, two or more copolyamides can be used, where the melting temperature of the resulting mixture is at least 145 degrees C.

The lower melting temperature semi-crystalline nylon can have the same general monomer selection as the higher melting temperature nylon, if desired. For example, a nylon 6/12 copolyamide which has a melting temperature of at least 145 degrees C., such as Grilon® CR 9 can be mixed with a second nylon 6/12 copolyamide which has a melting temperature less than 145 degrees C., for example about 130 degrees C. and available from EMS-Chemie AG under the trademark Grilon® CF 6S.

Thus, mixtures of these two nylon 6/12 copolyamides can be used as the relatively lower melting temperature semi-crystalline second component, and the relatively higher melting temperature semi-crystalline third component, to form the combination modifier for admixing with the first-component amorphous nylon.

Mixtures of one or more nylon 6/12 copolyamides with one or more nylon 6/66 copolyamides can, for example, be usefully employed in the invention as the relatively higher melting temperature semi-crystalline nylon. As another example, mixtures of multiple nylon 6/12 compositions can be employed as the relatively higher melting temperature semi-crystalline nylon.

According to the present invention, a nylon resin blend is provided comprising, as a first component of the blend, amorphous nylon, as a second component, a nylon, or nylon mixture having an effective melting temperature of less than 170 degrees C., and as a third component, a nylon or nylon mixture having an effective melting temperature which is at least 145 degrees C. and at least 10 degrees C., typically at least 20 degrees C., more typically at least 50 degrees C., higher than the melting temperature of the relatively lower melting temperature second component nylon. Thus, in selecting a set of second and third components for the nylon blend, not only is it necessary that each of the second and third components have melting temperatures within the recited ranges, it is also necessary that the melting temperatures of the second and third components exhibit the recited relationship to each other, in terms of relatively lower, and relatively higher, melting temperatures.

The first e.g. amorphous nylon component can be an amorphous nylon 6I/6T. A nylon 6I/6T having from about 65 to about 80 percent of its polymer units derived from hexamethyleneisophthalamide can be used, such as the Selar PA® 3426 mentioned above. The relatively lower melting temperature semi-crystalline nylon can be any nylon which exhibits the desired melting temperature characteristics relative to the relatively higher melting temperature semi-crystalline nylon, and which is compatible with forming a relatively homogenous polymer mixture with both the selected amorphous nylon and the selected relatively higher melting temperature nylon thus to obtain the desired properties.

Turning now to nylon blend compositions of the invention, an especially efficacious blend is about 20 percent by weight to about 55 percent by weight amorphous nylon, about 10 percent by weight to about 30 percent by weight nylon 6/69 and about 30 percent by weight to about 55 percent by weight nylon 6/66.

Another efficacious nylon blend composition is about 25 percent by weight to about 40 percent by weight amorphous nylon, about 10 percent by weight to about 25 percent by weight nylon 6/69 and about 35 percent by weight to about 55 percent by weight nylon 6/66.

Another efficacious nylon blend composition is about 35 percent by weight to about 52 percent by weight amorphous nylon, about 10 percent by weight to about 30 percent by weight nylon 6/69 and about 35 percent by weight to about 55 percent by weight nylon 6/66.

More generally stated, nylon blend compositions of the invention can be from about 10 percent by weight to about 65 percent by weight amorphous nylon, about 5 percent by weight to about 50 percent by weight nylon 6/69 or other relatively lower melting temperature semi-crystalline nylon, and about 10 percent by weight to about 85 percent by weight relatively higher melting temperature semi-crystalline nylon, optionally including nylon terpolymer. Where the relatively higher melting temperature nylon is present in an amount of greater than 55 percent by weight of the layer composition, the ratio of the relatively higher melting temperature nylon to the relatively lower melting temperature nylon is typically between about 4.5/1 and about 17/1.

Generally, the ratio of relatively higher melting temperature nylon to relatively lower melting temperature nylon is about 5/1 up to about 17/1, optionally about 6/1 to 17/1.

In yet another family of embodiments, nylon blend compositions of the invention can be from about 20 percent by weight to about 55 percent by weight amorphous nylon, about 10 percent by weight to about 30 percent by weight nylon 6/69 or other relatively lower melting temperature semi-crystalline nylon and about 40 percent by weight to about 55 percent by weight nylon 6/66 or other relatively higher melting temperature nylon.

Optionally, an additional semi-crystalline nylon also having a relatively higher melting temperature, relative to the melting temperature of the relatively lower melting temperature semi-crystalline nylon, can be employed as part of some of the relatively higher melting temperature semi-crystalline nylon component. For example, a homopolymer such as nylon 6, nylon 66, nylon 11, or nylon 12 or another copolymer such as nylon 6/66 can be added to the blend as the additional semi-crystalline nylon component.

Unless otherwise specified, all weight percentages herein are based upon the total weight of the material used in a given composition or layer.

Addressing the broad scope of amorphous nylon blend compositions of the invention which employ any of a wide variety of second and/or third semi-crystalline nylon blend components, the amorphous nylon can be present in the blend in an amount of from about 15 percent by weight to about 65 percent by weight based on the total weight of the blend composition. Typically, the amorphous nylon is present in an amount of at least 20 percent by weight in order to achieve desired levels of shrink capacity. Amounts greater than 65 percent by weight amorphous nylon can have deleterious effect on processability, particularly with respect to producing biaxially oriented films. Bubble formation becomes increasingly difficult as the amorphous nylon fraction is increased above 65 percent. Without being limited by theory, the inventors contemplate that, at greater than 65 percent by weight amorphous nylon, there can be insufficient quantity of the relatively lower melting temperature nylon to disrupt the amorphous nylon matrix to the extent necessary to facilitate flow of the amorphous nylon during biaxial orientation, or insufficient quantity of the relatively higher melting nylon to sustain bubble integrity.

Beneficially, the combination of the relatively lower melting temperature semi-crystalline nylon and the relatively higher melting temperature semi-crystalline nylon, is present in the blend in an amount of from about 35 percent by weight to about 85 percent by weight, based on the total weight of the blend. At amounts outside the recited range, orientation of a film of the blend becomes increasingly difficult, particularly for biaxial orientation using double bubble-type processes. Relatively higher amounts of especially the relatively lower melting temperature semi-crystalline nylon component are contra-indicated because of cost.

In some implementations, the amorphous nylon is about 20 percent by weight to about 55 percent by weight of the blend composition, the second component is greater than 18 percent by weight to about 30 percent by weight of the blend composition, and the third component is about 40 percent by weight to about 55 percent by weight of the blend composition.

In some instances, the amorphous nylon is about 25 percent by weight to about 40 percent by weight of the blend composition, the second semi-crystalline nylon component is about 12 percent by weight to about 20 percent by weight of the blend composition, and the third semi-crystalline nylon component is about 45 percent by weight to about 55 percent by weight of the blend composition.

In some instances, the amorphous nylon is greater than 30 percent by weight to about 40 percent by weight of the blend composition, the second semi-crystalline nylon component is about 10 percent by weight to about 25 percent by weight of the blend composition, and the third semi-crystalline nylon component is about 40 percent by weight to about 55 percent by weight of the blend composition.

In the context of the combination of nylon 6/69 and nylon 6/66 as the modifiers, the amorphous nylon can be present in a range of about 15 percent by weight to about 55 percent by weight, the nylon 6/69 can be present in an amount of greater than 18 percent by weight up to about 35 percent by weight, and the nylon 6/66 can be present in an amount of about 30 percent by weight to about 55 percent by weight.

In particular combinations of nylon 6/69 and nylon 6/66 as the semi-crystalline modifiers, the amorphous nylon is present in a range of about 15 percent by weight to about 65 percent by weight, the nylon 6/69 is present in an amount of about 5 percent by weight to about 35 percent by weight, and the nylon 6/66 is present in an amount of greater than 30 percent by weight to about 55 percent by weight, whereby the semi-crystalline nylon portion of the composition is about 85 percent by weight to about 35 percent by weight of the composition.

In certain combinations of nylon 6/69 and nylon 6/66 as the modifiers, the amorphous nylon is present in a range of about 15 percent by weight to about 65 percent by weight, the nylon 6/69 is present in an amount of greater than 18 percent by weight to about 50 percent by weight, and the nylon 6/66 is present in an amount of about 10 percent by weight to about 55 percent by weight.

In general, a relatively low melting temperature nylon 6/12 can be used in place of or in addition to any mentioned low melting temperature nylon 6/69.

Where the relatively higher melting temperature third component semi-crystalline nylon includes terpolymer, the amount of amorphous nylon in the blend composition can be about 15 percent by weight to about 65 percent by weight amorphous nylon. The amount of the relatively lower melting temperature semi-crystalline nylon second component can be about 5 percent by weight to about 50 percent by weight of the overall blend composition. The amount of the relatively higher melting temperature semi-crystalline nylon third component can be about 10 percent by weight to about 65 percent by weight of the overall blend composition. In this set of embodiments, the relatively higher melting temperature third component nylon can be defined entirely by nylon terpolymer or by a combination of nylon terpolymer and nylon copolymer such as nylon 6/66, or by a combination of nylon terpolymer and nylon homopolymer such as nylon 6, or by a combination of nylon terpolymer, nylon copolymer, and nylon homopolymer.

A variety of nylon terpolymers can be used as and/or in the relatively higher melting temperature third component semi-crystalline nylon in compositions and films of the invention.

Exemplary of such terpolymers, and without limitation thereto, are those terpolymers derived from amide moieties used to make nylon 6, nylon 66, nylon 69, nylon 12, nylon 610, nylon MXD10, nylon MXD6, and nylon 6I. As a first non-exclusionary limitation, a terpolymer used in the invention must exhibit semi-crystalline behavior such as having a definite melting point temperature as detected by DSC. Second, in those cases where a nylon layer is juxtaposed so as to touch an EVOH layer, as with all of the nylon compositions used herein, the terpolymer must be suitably non-reactive relative to the EVOH to not interfere with normal functions and/or features of the EVOH layer. Exemplary of such nylon terpolymers useful in the invention is a nylon 6/66/12 having a melting temperature of 190 degrees C. and available from UBE Engineering Plastics S.A., Castellón, Spain, under the name Terpalex 6434 B®. Another useful such nylon terpolymer is a nylon 66/69/6I having a melting temperature of 172 degrees C., available from EMS Chemie under the name Grilon BM 17 SBG®.

In nylon compositions which include nylon terpolymer, in one set of embodiments, the overall composition is about 20 percent by weight to about 50 percent by weight amorphous nylon, about 10 percent by weight to about 30 percent by weight of the relatively lower melting temperature second component semi-crystalline nylon, and about 40 percent by weight to about 65 percent by weight of the relatively higher melting temperature third component semi-crystalline nylon.

In another set of embodiments which include nylon terpolymer, the overall composition is about 30 percent to about 40 percent by weight amorphous nylon, about 10 percent by weight to about 20 percent by weight of the relatively lower melting temperature second component semi-crystalline nylon, and about 50 percent by weight to about 65 percent by weight of the relatively higher melting temperature third component semi-crystalline nylon.

In some embodiments, nylon-based films of the invention include greater than 30 percent by weight to about 65 percent by weight of the amorphous nylon and less than 70 percent by weight to about 35 percent by weight of the semi-crystalline nylon modifier, wherein the semi-crystalline nylon modifier component is selected from the group consisting of nylon 6 homopolymer, nylon 6/66 copolymer, nylon 6/12 copolymer, nylon 6/69 copolymer, terpolymers comprising moieties of at least one of nylon 6, nylon 66, nylon 12, nylon 6I, and nylon 69, and blends of such homopolymers, copolymers, and terpolymers.

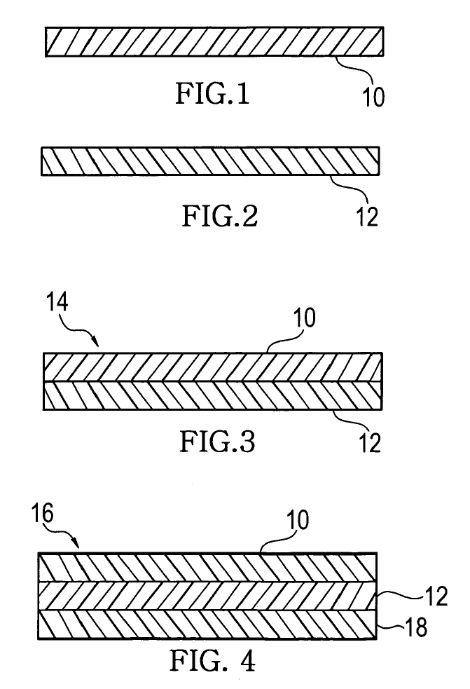

The nylon blend compositions of the invention which include amorphous nylon in the above noted amounts can be processed into single layer films, such as the single layer nylon-based film 10 illustrated in FIG. 1. The second and third nylon components can be combined with EVOH and extruded to form the single layer EVOH-based film 12 illustrated in FIG. 2. The nylon blend compositions are also susceptible to being coextruded with any of a wide variety of other polymer materials which are known to be coextrudable with nylon-composition layers. Specifically, the nylon blend compositions of the invention are coextrudable with a wide variety of olefinic homopolymers and copolymers, especially ethylene homopolymers and copolymers. Indeed, the nylon blend compositions of the invention can be coextruded with EVOH compositions to make multiple-layer films containing

/Nylon/EVOH/

combinations, wherein either or both of the nylon layer and the EVOH layer are modified by semi-crystalline nylon modifier. Such 2-layer film is illustrated at 14 in FIG. 3, including nylon layer 10 and EVOH-based layer 12.

Further, the nylon blend compositions can be coextruded with EVOH compositions to make three layer films containing

/Nylon/EVOH/Nylon/

combinations, which include layers of nylon on opposing sides of an intermediate layer of EVOH. Such 3-layer film is illustrated at 16 in FIG. 4, including nylon layers 10 and 18 and EVOH layer 12. One or both, or none, of the nylon layers are nylon blends as taught herein. If neither of the nylon layers is so modified, then the EVOH layer is modified by one or more semi-crystalline nylon components, as taught herein.

Such films can be coextruded by the cast extrusion method wherein a flat sheet is extruded from a slot die onto a cylindrical chill roll. Such films can also be coextruded through a tubular die and either air quenched or water quenched, in well-known blown film and water quench processes. Such coextruded films are susceptible to stretch orientation by well-known stretching techniques such as, and without limitation, the tenter frame technique, which is typically associated with cast extruded films and the double bubble technique, which is typically associated with tubularly extruded films.

The stretch orientation of films of the invention can include stretch orienting the films to such extent that the films exhibit shrink amounts of greater than 30 percent, and up to about 50-57 percent, when exposed to 90 degrees C. for 2 seconds. Such shrink amounts are achieved in the nylon film layers which include the above-recited fractional amounts of amorphous nylon as taught with respect to nylon films. Shrink amounts of greater than 30 percent, greater than 36 percent, up to and greater than 40 percent, are achieved in modified EVOH layers of the invention when certain conditions are met. Where a modified nylon layer is combined with an EVOH layer, or two modified nylon layers lie directly against opposing surfaces of the EVOH layer, shrink capacity of greater than 44 percent, correspondingly in the range of 50 percent and greater, can be achieved. Greater shrink amounts, in some instances, can be achieved, especially where both the EVOH layer and the nylon layer are modified as recited herein.

Where a nylon layer lies directly against the EVOH layer, and has a formulation which corresponds to the modified nylon compositions of the invention, e.g. especially the amorphous nylon content, the nylon layer appears to function to strengthen and support the EVOH layer such that the tendency for the EVOH layer to fail is attenuated, and/or the ability to stretch-orient the film is facilitated. In general, the nylon layer includes a fraction of e.g. about 15 percent by weight to about 65 percent by weight of an amorphous nylon component and correspondingly about 85 percent by weight to about 35 percent by weight of a semi-crystalline nylon component, optionally about 20 percent by weight to about 55 percent by weight amorphous nylon and about 80 percent by weight to about 45 percent by weight semi-crystalline nylon.

The degree of improvement in functionality of a film which includes an EVOH layer is related in part to the specific properties of the EVOH polymer, itself, and in part to the specific composition and thickness of the nylon layer relative to the EVOH layer, as well as the composition and thickness of the EVOH layer. Thus, the capability of the EVOH layer to provide the performance properties desired for the film as a whole is a function of the combined compositions, thicknesses, and the like of the respective EVOH layer and any nylon layer associated directly with an opposing surface of the EVOH layer as well as especially the physical properties of other layers which may be e.g. coextruded with the nylon and/or EVOH layers. For example, EVOH layer orientation can be facilitated by supporting the EVOH layer on one or both opposing surfaces of the EVOH layer, and/or by carefully selecting the composition of the EVOH layer for its tolerance for orientation.

An EVOH layer, by itself, namely without benefit of blend compositions of the invention, even when using any of the stretchable-grade EVOH's, is known to be stretchable, using conventional air-cooled tubular extrusion technology, to a level which will achieve about 25 percent to about 30 percent shrink when exposed to 90 degrees C. for 2 seconds. In the invention, where the EVOH layer is supported on one or both sides by a blended nylon layer composition made according to the nylon compositions taught for making film herein, the EVOH layer can be stretch oriented to an extent which enables shrink, of the corresponding multiple-layer film, by typically at least about 45 percent, and up to about 55 percent, in at least one of the machine direction and the cross-machine/transverse direction, while maintaining the integrity of both the nylon layer(s) and the EVOH layer.

Returning to a discussion of layer compositions, the composition of the EVOH layer can be either a stretchable-grade EVOH, or a “regular” grade of EVOH, namely a grade which is not specifically formulated to be “stretchable”. In the alternative, the composition of the EVOH layer can be a combination of stretchable and regular grades of EVOH. As regular grades of EVOH, which are not specifically formulated to be stretchable, there can be mentioned as examples, and without limitation, the following materials:
Soarnol DT 2903®—29 mole percent ethylene, Nippon Synthetic Chemical Ind. Co., Osaka, Japan;
Soarnol AT 4403®—44 mole percent ethylene, Nippon Synthetic Chemical Ind. Co., Osaka, Japan;
EVAL G 156®—48 mole percent ethylene, EVAL Company of America, Pasadena, Tex., USA.

“Regular” EVOH materials which are not especially formulated for enhanced stretchability, such as those noted immediately above, are generally considered to be not stretchable and so are not generally used to make commercially valuable shrink films, absent the teaching of this invention.

A “stretchable” grade EVOH, as expressed by suppliers of such materials, is one which has enhanced stretch properties, and can be, for example, stretched to a greater extent than a comparable regular grade EVOH. A comparable EVOH is one having similar ethylene content, similar molecular weight and molecular weight distribution, and similar modifiers whether as comonomer moieties or as admixtures, or as part of a conventional processing additive package, except for the stretch feature modifier. An “effective stretchable” grade EVOH is a such EVOH which has been modified with a stretch modifier, and which exhibits such stretch enhancement in its stretch properties.

As grades of EVOH which are specifically formulated to be stretchable, there can be mentioned as examples, and without limitation, the following materials which are available from Kuraray Company, Osaka, Japan.

EVAL SP521 (XEP-1031)—27 mole percent ethylene content

EVAL SP451 (XEP-914)—32 mole percent ethylene content

EVAL SP292 (XEP-922)—44 mole percent ethylene content

The above-recited SP (XEP) grades of EVOH have been said to have been modified by addition of material which improves stretchability of the resulting polymer composition.

The EVOH materials which are especially formulated for enhanced stretchability, namely the EVAL SP® materials listed above, are known to be compatible with being stretched so as to achieve a maximum of about 28 percent to about 30 percent shrink when exposed to 90 degrees C. for 2 seconds.

Whether addressing EVOH which is formulated to be stretchable, or EVOH which is not formulated to be stretchable, the maximum amount of stretch which can be achieved is in part related to the mole fraction of ethylene in the EVOH polymer. In general, the higher the ethylene content, the greater the stretch capacity of a film made with the polymer. By contrast, in general the lower the ethylene content, the less the stretch capacity of a film made with the polymer.

As indicated above, in the invention, capacity of the EVOH layer to tolerate biaxial or uniaxial stretching is increased by supporting the EVOH layer on at least one side by a nylon layer whose composition includes the herein taught blend compositions for nylon films. Supporting the EVOH layer on both sides of the EVOH layer provides a still further increase in the capacity of the EVOH layer to tolerate biaxial or uniaxial orientation/stretching. Supporting the EVOH layer directly on both surfaces of the EVOH layer yet further enhances the capacity of the EVOH layer to tolerate biaxial or uniaxial orientation/stretching.

As an alternative to modifying the nylon layer in a

/nylon/EVOH/nylon/

structure or substructure, or in combination with modifying the nylon layer(s), in the invention, the EVOH layer, itself, can be modified to enhance the capacity of the EVOH layer to tolerate uniaxial or biaxial orientation/stretching and/or to enhance shrink capacity of the film. To that end, the inventors herein have surprisingly discovered that the stretch/shrink capacity of the EVOH layer is enhanced by combining, with the EVOH, the same general family of semi-crystalline nylons described above for use in modifying amorphous nylon. Especially the second-component, relatively lower melting temperature nylons, having melting temperature no greater than about 145 degrees C., and optionally selected from the families of nylon 6/69 and nylon 6/12 copolymers, are highly effective in modifying an EVOH-based layer. An exemplary such nylon which enhances the stretch/shrink properties, e.g. biaxial orientation of the EVOH layer, is a nylon 6/69 available under the name Grilon BM 13 SBG from EMS-Chemie AG, Switzerland, and having a melting temperature of 134 degrees C. A second exemplary such nylon is a nylon 6/12 available under the name Grilon CF 7, also from EMS-Chemie AG, having a melting temperature of 155 degrees C. A third exemplary nylon is a nylon 6/12 available under the name Grilon CF 6S, having a melting temperature of 130 degrees C., also available from EMS-Chemie AG.

The inventors herein have discovered that blending the above mentioned types of nylon with EVOH results in an EVOH layer which is not only more flexible than the unblended EVOH, but the EVOH is surprisingly more susceptible to uniaxial and biaxial orientation, and such films can achieve shrink capacities which have previously been unachievable in films which contain EVOH copolymer layers. Thus, there can be mentioned stretch capacities which enable shrink amounts of greater than the above-noted maximum of about 30 percent stretch. The actual stretch capacity is governed at least in part by the presence, or absence, of nylon layers on opposing sides of the EVOH, on the compositions of those nylon layers, on the ethylene fraction in the EVOH, on the thicknesses of the EVOH layer, and any participating nylon layer, on whether the EVOH is formulated for stretchability, on the fractional amount of the respective modifying nylon or nylons which is blended with the EVOH, and on the composition of the specific modifying nylon or nylons which are blended with the EVOH.

Addressing specifically the nylon modifier, the increase in stretch capacity of the EVOH is to some degree dependent on the fractional amount of nylon in the composition of the EVOH layer. Within a specified range of generally up to about 60 percent nylon, the greater the amount of nylon, the greater the capacity of the EVOH layer, made with a specific composition, to be stretched. Thus, as the quantity of nylon in the EVOH layer is increased, the capacity of the EVOH layer to be stretched is generally increased. Accordingly, an EVOH layer which contains 30 percent nylon typically has a greater stretch capacity than a corresponding EVOH layer which contains only 10 percent of the same nylon.

As the fraction of nylon increases, the oxygen barrier property of the EVOH layer is generally degraded, though one can readily design films of the invention which contain modifying nylon in the EVOH layer and still achieve excellent oxygen barrier properties. Thus, the actual selection of the fractional amount of the nylon modifier represents a balance of the need for stretch and shrink performance of the film, against the need for oxygen barrier performance of the film. The integrity of the film during both the orientation process, and the shrink process is, of course, paramount in any event.

Turning now to further examination of films of the invention, where the EVOH is a stretchable-grade EVOH, using conventional nylon layers on either side of an EVOH layer, a conventional five layer film of e.g.

/EVA/nylon/EVOH/nylon/EVA/

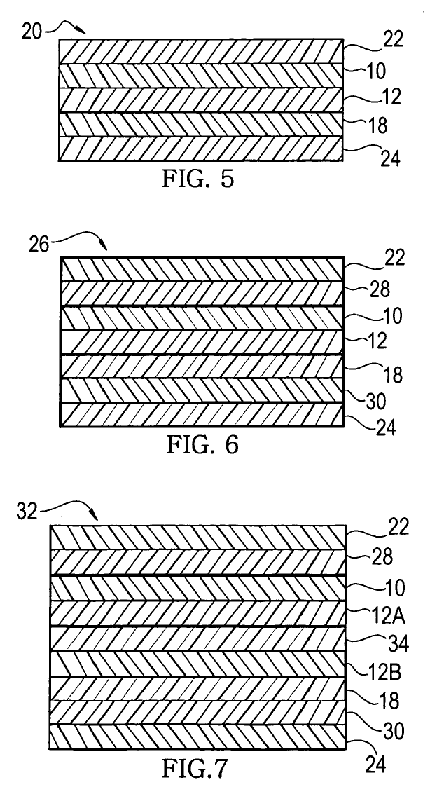

is illustrated in FIG. 5, where the film, itself, is designated 20, the nylon layers are designated and 18, the EVOH layer is designated 12, and the EVA layers are designated 22 and 24.

A seven layer film of e.g.

/PO/tie/nylon/EVOH/nylon/tie/PO/

is illustrated in FIG. 6, where the film, itself, is designated 26, the nylon layers are designated 10 and 18, the EVOH layer is designated 12, the outer polyolefin (PO) layers are designated 22 and 24, and the tie layers are designated 28 and 30. The films illustrated in FIGS. 5 and 6 have stretch capacities which are typically limited by e.g. the stretch capability of the EVOH layer, although the support and strengthening provided by e.g. the nylon layers enhance the overall stretchability of the film as a result of nylon modifiers used in any of layers 10, 12, and 18.

FIG. 7 illustrates a film 32 which has two EVOH core layers 12A and 12B separated by a tie layer 34. Nylon layers 10 and 18 interface with EVOH layers 12A and 12B, on the sides of the respective EVOH layers opposite tie layer 34. Tie layers 28 and 30 are between the respective nylon layers and outer polyolefins surface layers 22 and 24.

By modifying the nylon layers according to the compositions which employ amorphous nylon and the semi-crystalline nylons, as described herein in the context of nylon films, the stretch capacity of such multiple layer film which employs a regular grade EVOH, can be enhanced so as to achieve sufficient stretch capacity to provide at least about 28 percent shrink, optionally at least about 35 percent shrink, optionally at least about 38 percent shrink in at least one of the machine direction and the cross machine direction, when exposed to 90 degrees C. for 2 seconds. In some embodiments, sufficient biaxial orientation can be achieved to enable shrink capacity of about 40 percent to about 54 percent in at least one of the machine direction and the transverse direction, when exposed to 90 degrees C. for 2 seconds.

As an alternative, by modifying the EVOH by adding the above noted nylon 6/69 and/or nylon 6/12 to the EVOH composition, the stretch capacity of the film can be enhanced by the modification of the EVOH layer even if the nylon layer is not modified according to the invention.

In such EVOH blend compositions, the relatively lower melting temperature semi-crystalline nylon can be any nylon which exhibits the desired melting temperature characteristics and which can form a compatible polymer mixture with the EVOH. Where the relatively higher melting temperature semi-crystalline nylon is used, one can select any semi-crystalline nylon which can form compatible polymer mixtures with the combination of both the selected EVOH and the selected relatively lower melting temperature nylon thus to obtain the desired properties.

Where two nylon layers are used, e.g. one on each surface of the EVOH layer, where the compositions of the nylon layers are consistent with the nylon blend compositions described herein in the context of nylon films, and where the EVOH is modified by the addition thereto of either or both of nylon 6/69 and nylon 6/12, the enhancement benefits of the amorphous nylon fraction and/or the low melting temperature nylon fraction in the nylon layers, and the enhancement benefits of especially the low-melting temperature nylon fraction in the EVOH layer, are both expressed in a combined benefit to the resulting multiple-layer film. Such films can typically be stretched sufficiently to provide shrink of at least 38 percent and, in some cases up to about 56 percent at 90 degrees C., 2 sec in at least one of the machine direction and the transverse direction, while still providing good integrity of the film and excellent oxygen barrier.

To that end, an EVOH layer which incorporates therein a modifying nylon is at least 40 percent by weight EVOH, and contains at least 2 percent by weight of the modifying nylon. Thus, in its broadest expression, the EVOH layer is at least 40 percent by weight EVOH and up to about 98 percent by weight EVOH. By corollary, the modifying nylon polymer is present in an amount of at least about 2 percent by weight, up to about 60 percent by weight nylon.

In general, about 2 percent by weight semi-crystalline nylon, optionally at least about 5 percent by weight semi-crystalline nylon, is necessary in order that the physical properties of a resulting film made therefrom are modified to an extent sufficient to justify the resources needed to combine the nylon with the EVOH. As the fraction of nylon is increased, the stretch, and corresponding shrink, properties of the film are typically improved, while the oxygen barrier properties are somewhat diminished. So long as the values gained by the increased stretch and shrink properties outweigh the value lost in reduced oxygen barrier, the fraction of nylon can be beneficially increased in the EVOH layer. The EVOH layer must contain at least about 40 percent by weight EVOH in order to provide suitable level of oxygen barrier, while typical EVOH content is at least about 60 percent by weight.

The EVOH layer is generally about 5 percent by weight to about 40 percent by weight semi-crystalline nylon, optionally 10 percent by weight to about 30 percent by weight semi-crystalline nylon, with the balance of the polymer composition of the layer generally being the EVOH copolymer.

A still more typical fraction of the nylon in the EVOH layer is about 20 percent by weight to about 35 percent by weight nylon, with the 65 weight percent to 80 weight percent balance of the polymer composition of the layer generally being the EVOH copolymer. There can be mentioned, for example and without limitation, a composition which is about 70 percent by weight EVOH and about 30 percent by weight nylon 6/69 and/or nylon 6/12.

Where stretchable grade EVOH is used, typically at least 50 percent by weight, optionally at least 90 percent by weight, up to 100 percent by weight, of the EVOH in the respective layer is a stretchable grade EVOH, and any nylon modifier is present in the amount of from greater than zero up to about 50 percent by weight of the entire layer composition, and wherein the nylon is typically, but without limitation, nylon 6/69 and/or a relatively lower melting temperature nylon 6/12.

Where stretchable grade EVOH is used, the fraction of EVOH relative to nylon is typically about 50 percent by weight to about 95 percent by weight EVOH, optionally about 60 percent to about 90 percent by weight EVOH, further optionally 65 percent by weight to about 85 percent by weight EVOH, and yet further optionally about 70 percent by weight EVOH to about 80 percent by weight EVOH with, in all implementations, the balance, or most of the balance, of the layer being semi-crystalline nylon. The properties of the semi-crystalline nylon, the composition of the semi-crystalline nylon, and the prospect for two or more semi-crystalline nylons to be present, are as stated elsewhere herein with respect to the semi-crystalline component of the EVOH layer. There is, however, the objective of enhancing at least one of the properties of the film by incorporation of the nylon into the EVOH layer, such properties as for example and without limitation, increased stretch amount, increased shrink amount in at least one direction, improved optical properties, or increased uniformity of the thickness of one or more of the layers of the film.

In some embodiments, 10 percent by weight to 40 percent by weight nylon 6/69, or nylon 6/12 having a melting temperature of less than 170 degrees C., or both, is mixed with stretchable grade EVOH, and the resulting mixture can be extruded and biaxially oriented so as to provide at least 38 percent shrink in at least one of the machine direction or the transverse direction when exposed to 90 degrees C. for 2 seconds.

Typically, where more than one semicrystalline nylon polymer or copolymer is used as the modifier in especially the EVOH layer, at least 50 percent by weight of the modifying nylon is nylon 6/69 or nylon 6/12.

The present invention contemplates non-shrink blown films as well as uniaxially or biaxially oriented shrink films.

Surface layers of multiple-layer films of the invention can be made of any suitable resins or resin blends which are compatible with use of the EVOH layer and any internal nylon layer(s). Non-limiting examples of resins suitable for use on the outer surfaces of the film include polyolefin resins such as polypropylene (PP), LDPE, LLDPE, MDPE, VLDPE, and ethylenic copolymers and/or blends, including e.g. EVA, ethylene methyl acrylate copolymer, ethylene methacrylic acid copolymer, and the like. Other examples of suitable resins for use in a film, and outwardly of the EVOH layer and any nylon layer, include polyesters, other nylons, ionomers, PVDC, and various blends thereof.

Preferred components of the layers, which are between the EVOH layer and an outer surface of the film, are LLDPE, VLDPE, EVA and blends thereof. LLDPE refers to the conventional definition of such polymers in the art, which are copolymers of ethylene with one or more comonomers selected from preferably C₄ to C₁₀ alpha-olefins such as butene-1, hexene, or octene, in which long chains of copolymer are formed with relatively few side chain branches or cross-linking. The degree of branching is less than that found in typical conventional low or medium density polyethylene. LLDPE can also be characterized by the known low pressure, low temperature processes used for its production. LLDPE is known to have a density of between about 0.91 and 0.93 g/cc and a melting temperature of about 120 degrees C.

VLDPE refers to the conventional definition of such polymers in the art, which are copolymers of ethylene and at least one comonomer selected from C₄ to C₁₀ alpha-olefins and having a density between about 0.86 and 0.91 g/cc and a melting temperature of about 120 degrees C.

EVA is a copolymer of ethylene and vinyl acetate. EVA resins useful in the invention typically comprise about 1 percent by weight to about 20 percent by weight vinyl acetate, and optionally about 6 percent by weight to about 15 percent by weight vinyl acetate. Advantageously, EVA can be blended with LLDPE or VLDPE or both, to make various blend compositions which can be useful in layers which are located between any EVOH layer or nylon layer, and the closest outer surface of the film.

Also, adhesives e.g. tie resins, can be used in one or more of the layers, especially a layer which lies directly adjacent a nylon layer, or directly adjacent the EVOH layer; or adhesive tie layers can be disposed between selected layers in the film to enhance bonding of the respective layers to each other. For example, in a five layer film having the general structure

/EVA/nylon/EVOH/nylon/EVA/,

an EVA-based adhesive/tie resin can be used as the outer layer, or a tie resin concentrate can be blended with a conventional EVA resin, and used to form one or more layers thereby to enhance adhesion to the nylon layer. In the alternative, the tie resin composition can be fabricated into a separate layer disposed between an EVA layer and the respective nylon layer. Further, a tie resin composition layer can be fabricated into a separate layer disposed between the EVOH layer and one or both of the nylon layers. Structures which are exemplary of the embodiments shown in FIG. 6 can be illustrated as

/EVA/tie/nylon/EVOH/nylon/tie/EVA/

/LLDPE/tie/nylon/EVOH/nylon/tie/LLDPE/

/EVA/tie/nylon/EVOH/nylon/tie/LLDPE/

Similarly, structures which are exemplary of the embodiments shown in FIG. 7 can be illustrated as

/EVA/tie/nylonitie/EVOH/tie/nylon/tie/EVA/

/LLDPE/tie/nylon/tie/EVOH/tie/nylon/tie/LLDPE/

/LLDPE/tie/nylon/tie/EVOH/tie/nylon/tie/EVA/.

/PO/tie/nylon/EVOH/tie/EVOH/nylon/tie/PO/

/PO/tie/nylon/EVOH/tie/nylon/EVOH/tie/PO/

/PO/EVA/tie/nylon/EVOH/nylon/tie/EVA/PO/

Suitable tie resins include, without limitation, anhydride-modified EVA and/or LLDPE resins. Typical tie resins are ethylene based polymers containing carboxyl functionality, for example, those sold by DuPont Company under the brand name Bynel®, by Mitsui Chemicals Company under the name Admer®, and by Equistar Chemical Company under the name Plexar®.

It has been surprisingly discovered that modified nylon layers of the invention, on opposing sides of the EVOH layer, provide substantial improvement in the susceptibility of the film to orientation. Substantial improvements in orientation susceptibility can be achieved even with regular, namely non-stretch-grade, EVOH. Thus, where modified nylon layers are disclosed herein as being employed along with the EVOH layer, the EVOH layer need not be modified with the nylon compositions as disclosed here, whereby the EVOH layer can be substantially 100 percent by weight EVOH. Accordingly, by employing one or more modified nylon layers with the EVOH layer, the full oxygen barrier potential of the EVOH layer can be achieved while obtaining a film having excellent orientation capabilities, stretch capabilities, and shrink capabilities. As desired, the EVOH layer can be modified with the nylon components as discussed herein, for further enhanced orientation and shrink properties.

Given that the nylon modification of the EVOH layer provides substantial stretchability to the modified EVOH layer, the invention also contemplates a family of films which employ less than the above-noted two nylon layers. Thus, there can be mentioned multiple layer films which employ a nylon layer on one side of the modified EVOH layer but not on the opposing side of the modified EVOH layer. There can also be mentioned multiple layer films which are devoid of supporting nylon layers.

Thus, tie layers or other polymers which suitably adhere to the EVOH can be disposed on either side of the EVOH layer—or a nylon layer can be employed on one side of the EVOH layer but not on the opposing side. The layers disposed outwardly of those layers which are in contact with the EVOH layer can be selected for any desired property which is compatible with the use intent of the film, and need not be selected for any ability to assist in stretching the EVOH layer.

The following structures are illustrative, but not limiting, of multiple layer films which employ a modified EVOH layer:

/EVA/tie/EVOH/tie/EVA/

/EVA/tie/EVOH/tie/LLDPE/

/EVA/tie/EVOH/tie/EVA-LLDPE blend/

/EVA/tie/EVOH/nylon/EVA/

/EVA/EVA/tie/EVOH/nylon/tie/EVA/

/EVA/EVA/tie/EVOH/nylon/tie/LLDPE/

/PO/tie/nylon/EVOH/nylon/tie/PO/

/EVA/EVA/tie/EVOH/tie/EVA/EVA/

/EVA/EVA/tie/EVOH/tie/EVA/LLDPE/

/EVA/EVA/tie/EVOH/tie/EVA/EVA-LLDPE blend/

While EVA and LLDPE are illustrated in the above structures, as well as elsewhere in this teaching, as polymers used at and adjacent the outer surfaces of the film, other materials can be selected according to the expected use of the film. Thus, there can be mentioned a wide variety of polyolefins and other polymers well known to be combinable with EVOH in various film structures. As polyolefins, there can be mentioned, for example and without limitation, LDPE, medium density polyethylene (MDPE), high density polyethylene (HDPE), VLDPE, EMA, EMAA, ionomer, PP, ethylene propylene copolymers, and the like, as well as compatible blends of such materials.

In general, such films are coextruded. However, additional layers can be added by conventional and well known coating and/or lamination procedures. In addition, layers can be formed in a coextrusion process, and one or more layers later stripped away to expose a layer which was on the interior of the film when the film was extruded.

In making blend compositions of the invention, mixed/blended resin pellet combinations and any additives, are introduced to an extruder (generally one extruder per layer) where the resins are melt plastified by heating and mechanical working, and are then transferred to an extrusion (or coextrusion) die for formation into a tube or sheet as the case may be. Where two identical layers are used in a film, a single extruder can sometimes be used in fabricating those two layers.

Extruder and die temperatures are generally specified in accord with the particular resin or resin-containing mixtures being processed. Suitable processing temperature ranges for commercially available resins are generally known in the art, or are provided in technical information provided by resin suppliers. Processing temperatures can vary depending upon other process parameters chosen. In coextruding films of the invention, barrel and die temperatures, for example, commonly range between about 175 degrees C. and about 250 degrees C. However, depending upon the manufacturing process used, the particular equipment, and other process parameters utilized, actual process parameters, including process temperatures, can be set by those skilled in the art without undue experimentation.

In one known coextrusion type of double bubble process for tubular extrusion, as described in U.S. Pat. No. 3,456,044, herein incorporated by reference in its entirety, the primary tube leaving the die is inflated by admission of air. The tube is cooled, is collapsed, and then is reheated to the film's orientation (draw) temperature range, and is oriented by reinflating the tube to form a second bubble. Machine Direction (MD) orientation is produced by pulling on the re-inflated tube e.g. by utilizing two pairs of rollers travelling at different speeds. Transverse Direction (TD) orientation is obtained by radial expansion of the bubble. The thus biaxially oriented tube is fixed in its oriented, stretched, condition by cooling the stretched film. MD and TD stretch ratios are from about 2.0/1 to about 3.0. Shrink capacity of the stretched film is about 30 percent up to about 55 percent or more in at least one of MD or TD as illustrated by the examples set forth herein, when exposed to 90 degrees C. for 2 seconds.

Oriented single layer films e.g. either oriented EVOH films or oriented nylon films incorporating the recited amounts of amorphous and/or semi-crystalline nylons, can be made by various processes known in the art and including separating the other layers from the EVOH and/or nylon layers by delamination to expose a single EVOH layer or a single nylon layer. The orientation of films of the invention can improve certain physical properties of the films such as optical properties, tensile strength, toughness, etc. The film can be stretched in the machine direction only (uniaxial stretching), or stretched sequentially, e.g. MD stretching first followed by TD stretching, or simultaneously stretched MD and TD.

Experimental results of the following examples are based on shrink tests corresponding to the following test methods.

Shrink percentage is defined to be the values obtained by measuring unrestrained shrink which is obtained by fabricating the oriented film in an in-line double-bubble process; and then within about 2 hours of having fabricated the film, exposing samples of the film to a 90 degrees C. water bath for 2 seconds. Four test specimens are cut from a given sample of the film to be tested. The specimens are cut to 10 cm in the machine direction by 10 cm. in the transverse direction. Each specimen is completely immersed for 2 seconds in a 90 degrees C. water bath with no external tension being applied to the sample. The sample is removed from the water bath and allowed to return to room temperature. The distance between the ends of the shrunken specimen is measured. The difference in the measured distance for the shrunken specimen and the original 10 cm. is multiplied by ten to obtain shrink percentage for the specimen. The shrink percentage for the four specimens in the machine direction is averaged to arrive at the MD shrink percentage of the given film sample. The shrink percentage for the four specimens in the transverse direction is averaged to arrive at the TD shrink percentage.

In general, and now addressing both the modified EVOH layers of the invention and the modified nylon layers of the invention, the modifying semi-crystalline relatively lower melting temperature nylon component of the respective layer is typically present in an amount of at least 5 percent of the total weight of the respective layer in order to provide an incremental performance enhancement to the stretch/shrink properties of the respective layer, although some improvement is seen with as little as 2 percent by weight modifier.

Beneficially, in food packaging applications such as for meat or poultry, a thermoplastic film or film layer comprising an amorphous nylon copolymer and semi-crystalline polyamide blend according to the present invention will preferably range in thickness from about 7.5 microns to about 125 microns. Thinner and thicker films, while still of the invention, become weaker or more costly or less flexible, respectively. Generally, in food packaging applications, multiple layer films having a sufficient array of desired properties have thicknesses in the range of 37 to 100 microns.

In a typical 5-layer food packaging embodiment of films of the invention, the multiple layer film structure utilizes an internal EVOH core layer which acts as an oxygen barrier layer and comprises about 5 percent to about 25 percent of the total thickness of the multiple layer film. The outer layer of the film, which outer layer is adapted for placement adjacent a food product, is generally about 20 percent to about 40 percent of the total thickness of the film. The opposing outer layer is typically about 15 percent to about 25 percent of the total thickness of the film. Each nylon layer which lies close to the EVOH layer is typically about 5 percent to about 25 percent of the total thickness of the film.

Certain properties such as puncture resistance of the multiple layer films of the invention at high temperature can be improved by irradiation and/or cross-linking according to known methods. If and as desired, the entire film can be irradiated after, or before, orientation. Alternatively, one or more layers can be oriented and irradiated and optionally formed into a multiple layer film, along with other irradiated or non-irradiated layers, by lamination processes. A suitable irradiation dosage is irradiation up to 10 Mrad with irradiation from 1 to 7 Mrad being typical. Known irradiation procedures can be utilized.

Multiple layer films of this invention are typically produced by a coextrusion process with either air cooling or water quenching, using a double bubble orientation method. The extruder screws and dies used in the following examples are designed such that desired multiple layer films are coextruded by conventional processing procedures. Multiple layer films of the invention can also be fabricated by lamination processes wherein each layer is produced and then the respective layers are combined using various known combining technologies such as adhesive lamination or solvent-less lamination.

Where the nylon layer is recited or required to lie directly adjacent the EVOH layer, the nylon layer is considered to fulfill this requirement or recitation when a tie layer lies between the respective nylon layer and the EVOH layer.

For any polymeric material employed in structures of the invention, any conventional additive package can be included. For example and without limitation, slip agents, anti-block agents, release agents, anti-oxidants, plasticizers, and pigments, can be incorporated into one or more layers of the films of the invention, generally in small amounts of up to about 5 percent by weight, as is well-known in the art, thus to facilitate control, e.g. processing, of the polymeric material, as well as to stabilize and/or otherwise control the properties of the finished processed product.

### EXAMPLES

In the following examples, multiple layer films were produced using 5-layer air cooled tubular coextrusion apparatus and 7-layer water quench tubular extrusion apparatus.

The following parameters represent the general processing conditions used in making the films of the examples.

Extrusion temperature profiles.
EVA layers: Extruder Temperatures: 150-190° C., Die Temperatures: 190-210° C.
Tie layers: Extruder Temperatures: 160-225° C., Die Temperatures: 205-225° C.
Nylon layers: Extruder Temperatures: 200-240° C., Die Temperatures: 230-250° C.
EVOH layer: Extruder Temperatures: 170-230° C., Die Temperatures: 210-230° C.

Air Cooling temperature, incident air: 16-22° C.

Water Cooling temperature, water bath: 20-25° C.

Reheating temperature of primary tube, 85-100C.

Primary tube thickness: 260-600 microns.

Final film thickness: 40-65 microns.

The examples are generally represented as individual columns in the following 5 tables. In each table, each structure represented in that table is generically identified, at the head of that table, by a letter designation “A”, “B”, “C”, and the like, followed by a representation of the materials used in that structure, in layer order according to the sequence of appearance of the respective layers in that structure. The relative thicknesses of the respective layers are indicated in the same order, following the materials designation for each structure. “Inner” and “outer” indicators are used proximate the materials representations to indicate the inner and outer surfaces of the structures.

Overall thickness of the primary, unoriented tube is indicated with respect to each example. Extruder and die temperatures were as stated above. The primary tubes were quenched according the respective processes. The cooled tubes were in-line re-inflated in a typical double-bubble biaxial orientation process after reheating. Since a wide variety of structures and materials were used in the examples, the exact reheat temperature for a given example was to some extent a function of the structure and materials used in the respective example as known by those skilled in the art. The oriented tube was cooled and collapsed using conventional cooling and collapsing apparatus, and wound up. After the film had reached ambient temperature, samples of the oriented films were taken and subjected to shrink testing.

The tables show the composition of each nylon layer and each EVOH layer. The remaining layers are all EVA with or without a tie material as indicated, or ionomer. The outer surface layer, which was disposed away from packaged product, was ELVAX 3135 SB, 12 percent vinyl acetate, from DuPont Company, Wilmington, Del. The inner surface layer, which was disposed toward the packaged product, was ELVAX 3129, 10 percent vinyl acetate, also from DuPont. The ionomer was a blend of 50% Surlyn 1707 and 50% Surlyn 1855 from DuPont. The tie material was a blend of 65% by weight Bynel 41E710 and 35% by weight TRITHEVA 8093, 12 percent vinyl acetate, available from Petroquimica Triunfo S.A., Porto Alegre, Brazil.

The structure used for a specific example is shown in a separate row below the example number. The polymer materials used in the respective examples, other than the EVA, tie, and ionomer, are listed for each example in the tables. EVA, tie, and ionomer are consistent for a given structure.

Table 1 illustrates use of the nylon blend compositions of the invention as a single layer which exerts substantial affect on biaxial orientation properties, and shrink properties, of the film.

Table 2 illustrates use of the EVOH blend compositions of the invention as a single layer which exerts substantial affect on biaxial orientation properties, and shrink properties, of the film.

Table 3 illustrates use of 2-layer orientation control where the nylon blend compositions of the invention are used in a first layer which exerts substantial affect on biaxial orientation properties, and shrink properties, of the film, along with a second EVOH layer which also exerts substantial affect on the biaxial orientation properties, and shrink properties, of the film. The nylon layer represents blend compositions in all of the examples of Table 3, whereas the EVOH layer represents blend compositions in some of the examples, and is 100% EVOH in other examples, all as indicated in Table 3.

Table 4 illustrates use of 2-layer orientation control where the EVOH blend compositions of the invention are used in a first layer which exerts substantial affect on biaxial orientation properties, and shrink properties, of the film, in combination with a second nylon layer which is devoid of the amorphous nylon component, thus illustrating that the EVOH blend composition, in some instances, is sufficient to enable orientation of the film without the nylon layer comprising a 3-component nylon blend of the invention.

Table 5 illustrates use of 3-layer orientation control where an EVOH layer is positioned between opposing nylon layers, each of the three layers having substantial affect on orientation properties, and corresponding shrink properties, of the film. In Table 5, the two nylon-based layers are modified according to the blend compositions of the invention, in all of the examples. The EVOH layer is modified in some of the examples, and is not modified in others of the examples, in order to show, in part, the relative affects of modifying the nylon layers, compared to the affects of modifying the EVOH layer.

The materials used in the examples are as follows. Additional materials such as processing aids, for example slip, anti-block, and the like, as well as tie materials are also used.

| Material Name | Description | Supplier |
|---|---|---|
| Grivory G21 | amorphous nylon copolymer | EMS |
| Grivory FE 4495 | amorphous nylon copolymer | EMS |
| Grivory FE 4494 | amorphous nylon terpolymer | EMS |
| Grilon BM 13 SBG | nylon 6/69 mp 134 C. | EMS |
| Grilon CF 6S | nylon 6/12 mp 130 C. | EMS |
| Grilon CF 7 | nylon 6/12 mp 155 C. | EMS |
| Mazmid B-370 | nylon 6 mp 214-220 C. | Mazzaferro, |
| | | Brazil |
| Mazmid C-330 | nylon 6/66 mp 195-200 C. | Mazzaferro, |
| | | Brazil |
| Grilon XE-3698 | nylon 66/MXD10 mp 150 C. | EMS |
| Terpalex 6434 B | nylon terpolymer 6/66/12 mp 190 C. | UBE |
| Grilon BM 17 SBG | nylon terpolymer 66/69/6I | EMS |
| Soarnol AT 4403 | EVOH 44% ethylene | Nippon |
| | | Synthetic |
| Soarnol DT 2903 | EVOH 29% ethylene | Nippon |
| | | Synthetic |
| EVAL G-156 | EVOH, 48% ethylene | Kuraray |
| EVAL SP-292 | EVOH, 44% ethylene, stretch grade | Kuraray |
| EVAL SP-521 | EVOH, 27% ethylene, stretch grade | Kuraray |
| EVAL SP-451 | EVOH, 32% ethylene, stretch grade | Kuraray |
| ELVAX 3135 SB | EVA 12% vinyl acetate | DuPont |
| ELVAX 3129 | EVA 10% vinyl acetate | DuPont |
| Surlyn 1707 | Ionomer mp 92 C. | DuPont |
| Surlyn 1855 | Ionomer mp 88 C. | DuPont |
| Tritheva 8093, | EVA 12% vinyl acetate | Petroquimica |
| | | Triunfo. |

Examples 1-18 in Table 1 illustrate biaxially oriented films containing a nylon layer, wherein the nylon layer has a nylon composition of the invention. The amorphous nylon composition is illustrated as low as 10 percent by weight of the nylon layer at Example 18, and as high as 52 percent by weight of the nylon layer at Example 11. The relatively lower melting temperature nylon is illustrated as low as 5 percent by weight of the nylon layer at Example 18, and as high as 45 percent by weight of the nylon layer at Example 4. The relatively higher melting temperature nylon is illustrated as low as 20 percent by weight of the nylon layer at Example 4, and as high as 55 percent by weight of the nylon layer at Example 1. The greater of the MD or TD shrink amount/capacity in a given example is illustrated as low as 30.2 percent at Example 18 and as high as 57.2 percent at Example 9.

TABLE 1
Nylon Blend Variables

| | Example # | | | | | | | | | |
|---|---|---|---|---|---|---|---|---|---|---|
| | 1 | 2 | 3 | 4 | 5 | 6 | 7 | 8 | 9 | 10 |
| Structure: | A | A | A | A | A | A | A | A | A | A |
| Grivory G21 | 25% | 25% | 35% | 35% | 35% | 35% | 35% | 35% | 35% | 35% |
| Grivory FE 4494 | | | | | | | | | | |
| Grivory FE 4495 | | | | | | | | | | |
| Grilon BM 13 SBG | 20% | | 12% | 45% | | | 6% | | 15% | |
| Grilon CF 6S | | 30% | | | 12% | | 6% | 6% | | 15% |
| Grilon CF 7 | | | | | | 12% | | 6% | | |
| Mazmid C-330 | | 45% | 53% | | 53% | 53% | 53% | 53% | | |
| Mazmid B-370 | 55% | | | 20% | | | | | | |
| Terpalex 6434 B | | | | | | | | | 50% | 50% |
| Grilon XE-3698 | | | | | | | | | | |
| Grilon BM 17 | | | | | | | | | | |
| TD Shrink | 53.6% | 53.8% | 54.6% | 57.1% | 54.0% | 53.8% | 54.7% | 54.2% | 57.2% | 54.4% |
| MD Shrink | 39.5% | 37.8% | 40.6% | 39.6% | 37.4% | 37.3% | 37.6% | 37.2% | 41.5% | 40.3% |
| Tape Thickness | 260μ | 260μ | 260μ | 260μ | 260μ | 260μ | 260μ | 260μ | 260μ | 260μ |

| | Example # | | | | | | | |
|---|---|---|---|---|---|---|---|---|
| | 11 | 12 | 13 | 14 | 15 | 16 | 17 | 18 |
| Structure: | A | A | A | A | A | A | A | A |
| Grivory G21 | 52% | 52% | 25% | | 35% | 35% | | 10% |
| Grivory FE 4494 | | | | | | | 35% | |
| Grivory FE 4495 | | | | 52% | | | | |
| Grilon BM 13 SBG | 30% | 30% | | 30% | 15% | 15% | 15% | 5% |
| Grilon CF 6S | | | 30% | | | | | |
| Grilon CF 7 | | | | | | | | |
| Mazmid C-330 | 18% | | | 18% | | | | 85% |
| Mazmid B-370 | | | | | | | | |
| Terpalex 6434 B | | 18% | 45% | | | | 50% | |
| Grilon XE-3698 | | | | | | 50% | | |
| Grilon BM 17 | | | | | 50% | | | |
| TD Shrink | 55.9% | 55.6% | 51.6% | 53.7% | 55.1% | 50.7% | 53.4% | 29.4% |
| MD Shrink | 38.0% | 37.5% | 37.2% | 48.1% | 41.6% | 42.5% | 37.5% | 30.2% |
| Tape Thickness | 260μ | 260μ | 260μ | 260μ | 260μ | 260μ | 260μ | 260μ |

A - Structure: (inner)/EVA/tie/nylon blend//EVA + tie/EVA/(outer) [34/12/26/12/16%] (5-layers) air cooled

Examples 19-42 in Table 2 illustrate biaxially oriented films containing an EVOH-based layer, wherein the composition of the EVOH-based layer comprised an EVOH blend composition of the invention. Examples 43-49 are control experiments where the EVOH layer was 100 percent EVOH, including illustration of stretchable EVOH, without use of modifying nylon.

The EVOH component is illustrated as low as 60 percent by weight of the EVOH layer at Example 20, and as high as 90 percent by weight of the EVOH layer in blend composition at e.g. Example 36. The relatively lower melting temperature nylon is illustrated as low as 10 percent by weight of the EVOH layer at e.g. Example 36, and as high as 40 percent by weight of the EVOH layer at Example 20. Use of the relatively higher melting temperature nylon is illustrated at 10 percent by weight of the EVOH layer at Example 23.

The greater of the MD or TD shrink amount/capacity in any given example is illustrated as low as 17.4 percent at Example 29 and as high as 47.4 percent at Example 38.

The significance of Example 29 is that the control experiment using this 29 percent ethylene EVOH could not be inflated as shown in control Example 48, whereas the primary tube could be inflated as illustrated in Example 29 when the low melting temperature nylon was added as a modifier to the EVOH layer.

One can compare directly Examples 35 and 43, Examples 33 and 44, Examples 32 and 45, Examples 38 and 46, Examples 36 and 49, and Examples 40 and 47, to see the direct affect of adding e.g. BM-13 to the EVOH in the amount of 10%-20% BM-13 in the EVOH layer composition. All comparisons show an increase in shrink percent both in MD and TD. The average increase shrink is 7.7 percent MD and 6.0 percent TD.

Thus Table 2 shows that adding the low melting temperature nylon to the EVOH layer increased the shrink capacity of the film and, in the case of Soarnol DT 2903, enabled biaxial stretching as at Example 29 where the bubble could not be inflated when 100 percent EVOH was used in the EVOH layer as at Example 48.

TABLE 2
EVOH Blend Variables

| | Examples | | | | | | | | | | |
|---|---|---|---|---|---|---|---|---|---|---|---|
| | 19 | 20 | 21 | 22 | 23 | 24 | 25 | 26 | 27 | 28 | 29 |
| Category Letter | B | B | B | B | B | B | B | B | B | B | D |
| Soarnol DT 2903 | | | | | | | | | | | 70% |
| Soarnol AT 4403 | 70% | | | | | | | 70% | 70% | | |
| EVAL G-156 | | | | | | | | | | 70% | |
| EVAL EC 165 A | | | | | | | | | | | |
| EVAL SP292 | | 60% | 70% | 70% | 70% | 70% | 70% | | | | |
| EVAL XEP 914 B | | | | | | | | | | | |
| Grilon BM 13 SBG | 30% | 40% | 30% | 10% | 20% | | | 20% | | 30% | 30% |
| Terpalex 6434 B | | | | | 10% | | | | | | |
| Grilon CF 6S | | | | 10% | | 30% | 20% | 10% | 20% | | |
| Grilon CF 7 | | | | 10% | | | 10% | | 10% | | |
| TD Shrink | 32.4% | 35.7% | 36.2% | 35.8% | 31.7% | 28.8% | 27.8% | 29.8% | 22.9% | 32.7% | 17.4% |
| MD Shrink | 24.5% | 34.7% | 32.9% | 34.8% | 28.3% | 25.6% | 29.5% | 32.1% | 26.2% | 36.4% | 19.9% |
| Tape Thickness | 450μ | 500μ | 500μ | 500μ | 500μ | 500μ | 500μ | 500μ | 500μ | 500μ | 500μ |
| | Examples | | | | | | | | | | |
| | 30 | 31 | 32 | 33 | 34 | 35 | 36 | 37 | 38 | 39 | 40 |
| Structure: | D | D | D | D | D | D | E | E | E | F | F |
| Soarnol DT 2903 | | | | | | | | | | | |
| Soarnol AT 4403 | | | | | | | | | | | |
| EVAL G-156 | | | | | | | | 90% | 85% | 85% | |
| EVAL EC 165 A | 85% | 85% | 80% | | | | | | | | 85% |
| EVAL SP292 | | | | 85% | 90% | | 90% | | | | |
| EVAL XEP 914 B | | | | | | 80% | | | | | |
| Grilon BM 13 SBG | 15% | 15% | 20% | 15% | 10% | 20% | 10% | 10% | 15% | 15% | 15% |
| Terpalex 6434 B | | | | | | | | | | | |
| Grilon CF 6S | | | | | | | | | | | |
| Grilon CF 7 | | | | | | | | | | | |
| TD Shrink | 39.2% | 38.9% | 34.8% | 36.3% | 36.5% | 40.4% | 46.1% | 43.0% | 47.4% | 35.0% | 44.0% |
| MD Shrink | 29.4% | 26.4% | 28.6% | 27.0% | 21.7% | 31.9% | 36.2% | 35.2% | 38.6% | 28.3% | 35.0% |
| Tape Thickness | 500μ | 600μ | 600μ | 600μ | 600μ | 400μ | 300μ | 300μ | 300μ | 300μ | 300μ |

| | Example # | | | | | | | | |
|---|---|---|---|---|---|---|---|---|---|
| | 41 | 42 | 43 | 44 | 45 | 46 | 47 | 48 | 49 |
| Structure: | F | F | D | D | D | E | F | D | E |
| Soarnol DT 2903 | | | | | | | | 100% | |
| Soarnol AT 4403 | | | | | | | | | |
| EVAL G-156 | 90% | | | | | 100% | | | |
| EVAL EC 165 A | | 90% | | | 100% | | 100% | | |
| EVAL SP292 | | | | 100% | | | | | 100% |
| EVAL XEP 914 B | | | 100% | | | | | | |
| Grilon BM 13 SBG | 10% | 10% | | | | | | | |
| Terpalex 6434 B | | | | | | | | | |
| Grilon CF 6S | | | | | | | | | |
| Grilon CF 7 | | | | | | | | | |
| TD Shrink | 40.0% | 39.4% | 31.2% | 31.5% | 27.7% | 36.1% | 36.4% | CNI | 39.3% |
| MD Shrink | 32.0% | 32.1% | 29.1% | 17.8% | 18.5% | 29.8% | 30.4% | CNI | 35.7% |
| Tape Thickness | 300μ | 300μ | 400μ | 600μ | 600μ | 300μ | 300μ | 500μ | 300μ |

A: Structures: (outer)/EVA/EVA/tie/EVOH-variables/tie/EVA/EVA/(inner) [20/15/8/6/8/15/28%] (7-layer) - Water-Cooled
B: Structures: (outer)/EVA/tie/EVOH-variables/tie/EVA/(inner) [20/12/22/12/34%] (5-layer) - Air-cooled
C: Structures: (outer)/EVA/EVA/tie/EVOH-variables/tie/EVA/EVA/(inner) [20/12/8/12/8/12/28%] (7-layer) - Water-Cooled
D: Structures: (outer)/EVA/EVA/tie/EVOH-variables/tie/EVA/EVA/(inner) [18/10/8/22/8/10/24%] (7-layer) - Water-Cooled
E: Structures: (outer)/EVA/EVA/tie/EVOH-variables/tie/EVA/IONOMER/(inner) [18/10/8/22/8/10/24%] (7-layer) - Water-Cooled
F: Structures: (outer)/IONOMER/EVA/tie/EVOH-variables/tie/EVA/EVA/(inner) [18/10/8/22/8/10/24%] (7-layer) - Water-Cooled

Examples 50-64 in Table 3 illustrate biaxially oriented films containing both a nylon-based layer and an EVOH-based layer. The composition of the nylon-based layer reflects the nylon blend compositions of the invention. The EVOH-based layer is nylon-modified in some examples, and is unmodified in others, as indicated for each example.

The greater of the MD or TD shrink amount/capacity in any given example is illustrated as low as 32.6 percent at Example 64 and as high as 54.3 percent at Example 60.

Comparing Examples 51 and 52 illustrates that adding the relatively lower melting temperature nylon to the EVOH layer appears to have increased the shrink capacity of the film in the transverse direction. Respective ones of the examples illustrate the affect of using, in the nylon-based layer, the inventive nylon blend combinations of the invention, namely using the amorphous nylon, the relatively lower melting temperature nylon, and the relatively higher melting temperature nylon in the nylon blend composition.

TABLE 3
Nylon - Modified and EVOH (including modified)

| | Example # | | | | | | | | |
|---|---|---|---|---|---|---|---|---|---|
| | 50 | 51 | 52 | 53 | 54 | 55 | 56 | 57 | 58 |
| Structure | G | G | G | G | G | G | G | G | G |
| Grivory G21 | 35% | 35% | 35% | 35% | 35% | 35% | 35% | 25% | 60% |
| Grivory FE 4494 | | | | | | | | | |
| Mazmid C-330 | 50% | 50% | 50% | 50% | 50% | 50% | | | |
| Grilon BM 13 SBG | 15% | 15% | 15% | 15% | 15% | 7% | 15% | 5% | 30% |
| Grilon CF 7 | | | | | | 8% | | | |
| Terpalex 6434 B | | | | | | | 15% | | |
| Mazmid B-370 | | | | | | | | | |
| Grilon CF 6S | | | | | | | | | |
| Grilon BM 17 SBG | | | | | | | | | |
| Grilon XE-3698 | | | | | | | | | |
| Soarnol AT 4403 | 100% | | | | | 100% | 90% | | |
| Soarnol DT 2903 | | 100% | 70% | | | | | | |
| Eval SP-521 | | | | 100% | 90% | | | | |
| Eval G-156 | | | | | | | | 100% | 100% |
| Eval XEP-914 | | | | | | | | | |
| Eval SP-292 | | | | | | | | | |
| Grilon BM 13 SBG | | | 30% | | 10% | | | | |
| Grilon CF 6S | | | | | | | 10% | | |
| Grilon CF 7 | | | | | | | | | |
| TD Shrink | 43.8% | 51.6% | 53.2% | 52.6% | 52.6% | 47.7% | 51.4% | 51.6% | 45.5% |
| MD Shrink | 38.4% | 41.1% | 40.6% | 38.6% | 39.4% | 38.8% | 37.2% | 42.7% | 33.5% |
| Tape Thickness | 260μ | 260μ | 260μ | 260μ | 260μ | 260μ | 260μ | 260μ | 260μ |

| | Example # | | | | | | |
|---|---|---|---|---|---|---|---|
| | 59 | 60 | 61 | 62 | 63 | 64 | |
| Structure | G | G | G | G | G | G | |
| Grivory G21 | 25% | 25% | 35% | 35% | 35% | | NYLON |
| Grivory FE 4494 | | | | | | 20% | |
| Mazmid C-330 | 35% | 70% | 10% | 35% | | | |
| Grilon BM 13 SBG | 5% | 20% | 8% | | 15% | 15% | |
| Grilon CF 7 | 5% | | | | | | |
| Terpalex 6434 B | | | | | | 65% | |
| Mazmid B-370 | 30% | 55% | 50% | 30% | | | |
| Grilon CF 6S | | | 7% | 35% | | | |
| Grilon BM 17 SBG | | | | | 50% | | |
| Grilon XE-3698 | | | | | | | |
| Soarnol AT 4403 | | | | | | | EVOH |
| Soarnol DT 2903 | | | | | | | |
| Eval SP-521 | | | | | | | |
| Eval G-156 | | | | 20% | | | |
| Eval XEP-914 | 100% | 80% | | | 80% | | |
| Eval SP-292 | | | 100% | | | 100% | |
| Grilon BM 13 SBG | | | | 80% | 20% | | |
| Grilon CF 6S | | 20% | | | | | |
| Grilon CF 7 | | | | | | | |
| TD Shrink | 51.6% | 54.3% | 52.0% | 39.6% | 43.5% | 32.6% | |
| MD Shrink | 37.9% | 38.3% | 40.0% | 23.0% | 31.5% | 30.0% | |
| Tape Thickness | 260μ | 260μ | 260μ | 260μ | 260μ | 260μ | |

G - Structure: (inner)/EVA/EVA/Nylon/EVOH/EVA/EVA/EVA/(outer) [18/10/20/6/8/28%] (7-layer) - Water Cooled

Examples 65-68 in Table 4 illustrate films which contain a single EVOH-based layer and a single nylon-based layer. The composition of the EVOH-based layer in each of Examples 65-68 contains 20 percent by weight of a relatively lower melting temperature nylon. The nylon-based layer contains 100% relatively higher melting temperature nylon in Examples 65 and 66, and a combination of the relatively higher melting temperature nylon and the relatively lower melting temperature nylon in Examples 67 and 68.

The films of Examples 65 and 66 were inflated, with modest shrink capacities, while the films of Examples 67 and 68 could not be inflated. None of these examples contain any amorphous nylon in the nylon-based layer. In spite of the lack of amorphous nylon, the films of Examples 65 and 66 could still be biaxially stretched, as evidenced by the shrink data.

Choosing to not be bound by theory, the inventors herein contemplate that inflation of the films of Examples 65 and 66 may have been enabled by the presence of the relatively lower melting temperature nylons in the respective EVOH layers. However, other variables, such as differences in the thicknesses of the respective layers, may have also affected biaxial stretchability of the primary tubes.

All four examples had the same thickness for the primary tube. The thickness of the combination of the nylon-based layer and the EVOH-based layer was 26% of the structure thickness in Examples 65 and 66, and only 12% of the structure thickness in Example 67, only 18% of the structure thickness in Example 68. Inability to inflate the tubes of Examples 67 and 68 might be affected by the use of nylon 6, which is known to be harder than nylon 6/66 which was used in Examples 65 and 66. However, the lesser quantity of nylon and EVOH in the structures of Examples 67 and 68 may have played a role in the inability to inflate the tubes of Examples 67 and 68. Thus, the inventors contemplate that at least the compositions illustrated in the EVOH layers of Examples 67 and 68 are within the scope of the invention and routine experimentation can be used to establish suitable structures containing such compositions, especially where the nylon-based layer includes a recited amount of amorphous nylon.

TABLE 4
EVOH - modified and Nylon

| | Example # | | | | |
|---|---|---|---|---|---|
| | 65 | 66 | 67 | 68 | |
| Structure | H | J | K | L | |
| Mazmid C-330 | 100% | 100% | | | NYLON |
| Grilon BM 13 SBG | | | 30% | 30% | |
| Mazmid B-370 | | | 70% | 70% | |
| Eval SP-292 | 80% | 80% | 80% | 80% | EVOH |
| Grilon BM 13 SBG | 20% | | 20% | 20% | |
| Grilon CF 6S | | 20% | | | |
| TD Shrink | 28.0% | 35.0% | X | X | |
| MD Shrink | 22.0% | 26.0% | X | X | |
| Tape Thickness | 260μ | 260μ | 260μ | 260μ | |

H - Structure: (outer)/EVA/EVA/Nylon/EVOH/EVA/EVA/EVA/(inner) [ [symbol]
J - Structure: (outer)/EVA/EVA/EVA/EVOH/Nylon/EVA/EVA/(inner) [1 [symbol]
K - Structure: (outer)/EVA/EVA/EVA/EVOH/Nylon/EVA/EVA/(inner) [ [symbol]
L - Structure: (outer)/EVA/EVA/EVA/EVOH/Nylon/EVA/EVA/(inner) [2

[symbol]

Examples 69-93 in Table 5 illustrate biaxially oriented films, each containing an EVOH-based layer, the EVOH-based layer being supported on each side by a nylon-based layer. Table 5 illustrates the affect of using the nylon modification taught herein in each of the respective nylon-based layers and the EVOH-based layer.

The EVOH component is illustrated as low as 70 percent by weight of the EVOH layer such as at Example 73, and as high as 100 percent by weight of the EVOH layer at several of the examples. The relatively lower melting temperature nylon is illustrated as high as 30 percent by weight of the EVOH layer at e.g. Example 73. Use of the relatively higher melting temperature nylon is illustrated as high as 30 percent by weight of the EVOH layer at Example 92.

The compositions of the nylon layers in Table 5 generally reflect the same ranges of materials which are illustrated in Tables 1 and 3, and described elsewhere herein. The compositions of the EVOH layers generally reflect the same ranges of materials which are illustrated in Tables 2, 3, and 4, and described elsewhere herein.

TABLE 5
Nylon/EVOH/Nylon

| | Example # | | | | | | | | | | | | |
|---|---|---|---|---|---|---|---|---|---|---|---|---|---|
| | 69 | 70 | 71 | 72 | 73 | 74 | 75 | 76 | 77 | 78 | 79 | 80 | |
| Structure | M | M | M | M | M | M | M | M | M | M | M | M | |
| Grivory G21 | 35% | 35% | 35% | 40% | 40% | 40% | 40% | 40% | 40% | 40% | 40% | 40% | NYLON |
| Grivory FE 4494 | | | | | | | | | | | | | |
| Mazmid C-330 | 53% | 53% | 53% | 50% | 50% | 50% | 50% | 50% | 50% | 50% | 50% | 50% | |
| Grilon BM 13 SBG | 12% | 12% | 12% | 10% | 10% | 10% | 10% | 10% | 10% | 10% | 10% | 10% | |
| Grilon CF 7 | | | | | | | | | | | | | |
| Mazmid B-370 | | | | | | | | | | | | | |
| Grilon XE-3698 | | | | | | | | | | | | | |
| Grilon BM 17 SBG | | | | | | | | | | | | | |
| Terpalex 6434 B | | | | | | | | | | | | | |
| Soarnol AT 4403 | | | | | | 100% | 90% | | | 40% | | | EVOH |
| Soarnol DT 2903 | 100% | 85% | | 100% | 70% | | | | | | | | |
| Eval SP-521 | | | 80% | | | | | | | 60% | 100% | 80% | |
| Eval SP-292 | | | | | | | | 90% | 70% | | | | |
| Grilon BM 13 SBG | | 15% | 20% | | 30% | | 10% | 10% | 10% | | | | |
| Grilon BM 17 SBG | | | | | | | | | | | | | |
| Grilon XE-3698 | | | | | | | | | | | | | |
| Grilon CF 7 | | | | | | | | | 10% | | | | |
| Grilon CF-6S | | | | | | | | | 10% | | | 20% | |
| Grivory G21 | 35% | 35% | 35% | 40% | 40% | 40% | 40% | 40% | 40% | 40% | 40% | 40% | NYLON |
| Grivory FE 4494 | | | | | | | | | | | | | |
| Mazmid C-330 | 53% | 53% | 53% | 50% | 50% | 50% | 50% | 50% | 50% | 50% | 50% | 50% | |
| Grilon BM 13 SBG | 12% | 12% | 12% | 10% | 10% | 10% | 10% | 10% | 10% | 10% | 10% | 10% | |
| Mazmid B-370 | | | | | | | | | | | | | |
| Terpalex 6434 B | | | | | | | | | | | | | |
| Grilon BM 17 SBG | | | | | | | | | | | | | |
| TD Shrink | 46.3% | 52.0% | 55.6% | 44.9% | 54.0% | 50.0% | 50.0% | 53.1% | 50.2% | 50.8% | 51.2% | 52.4% | |
| MD Shrink | 39.3% | 38.0% | 41.5% | 30.6% | 36.0% | 39.8% | 40.0% | 36.7% | 33.3% | 39.1% | 38.2% | 36.0% | |
| Tape Thickness | 260μ | 260μ | 260μ | 260μ | 260μ | 260μ | 260μ | 260μ | 260μ | 260μ | 260μ | 260μ | |

| | Example # | | | | | | | | | | | | | |
|---|---|---|---|---|---|---|---|---|---|---|---|---|---|---|
| | 81 | 82 | 83 | 84 | 85 | 86 | 87 | 88 | 89 | 90 | 91 | 92 | 93 | |
| Structure | M | M | M | M | N | N | N | N | N | N | N | N | N | |
| Grivory G21 | 55% | 35% | | | | | | | 35% | | 10% | 35% | 35% | NYLON |
| Grivory FE | | | | | | | | | | 35% | | | | |
| 4494 | | | | | | | | | | | | | | |
| Mazmid | 40% | 30% | 100% | 100% | | | 80% | 100% | | | 85% | 53% | 53% | |
| C-330 | | | | | | | | | | | | | | |
| Grilon BM | 5% | 35% | | | | | 20% | | 15% | 15% | 5% | 12% | 12% | |
| 13 SBG | | | | | | | | | | | | | | |
| Grilon CF 7 | | | | | | | | | | | | | | |
| Mazmid | | | | | 100% | 100% | | | | | | | | |
| B-370 | | | | | | | | | | | | | | |
| Grilon | | | | | | | | | | | | | | |
| XE-3698 | | | | | | | | | | | | | | |
| Grilon BM | | | | | | | | | 50% | | | | | |
| 17 SBG | | | | | | | | | | | | | | |
| Terpalex | | | | | | | | | | 50% | | | | |
| 6434 B | | | | | | | | | | | | | | |
| Soarnol | | | | | 100% | 80% | | | | | | | | EVOH |
| ET 4403 | | | | | | | | | | | | | | |
| Soarnol | | | 80% | | | | | | | | 70% | | | |
| DT 2903 | | | | | | | | | | | | | | |
| Eval SP-521 | | | | | | | 100% | | | | | | | |
| Eval SP-292 | 90% | 100% | | 80% | | 10% | | 80% | 90% | 90% | | 70% | 70% | |
| Grilon BM | | | 20% | 10% | | 10% | | 20% | 10% | 10% | 30% | | | |
| 13 SBG | | | | | | | | | | | | | | |
| Grilon BM | | | | | | | | | | | | 30% | | |
| 17 SBG | | | | | | | | | | | | | | |
| Grilon | | | | | | | | | | | | | 30% | |
| XE-3698 | | | | | | | | | | | | | | |
| Grilon CF 7 | 10% | | | 10% | | | | | | | | | | |
| Grilon | | | | | | | | | | | | | | |
| CF-6S | | | | | | | | | | | | | | |
| Grivory G21 | 55% | 55% | 40% | 40% | 40% | 40% | 40% | | 35% | | 10% | 35% | 35% | NYLON |
| Grivory | | | | | | | | | | 35% | | | | |
| FE 4494 | | | | | | | | | | | | | | |
| Mazmid | 40% | 40% | 50% | 50% | 50% | 50% | 50% | 100% | | | 85% | 53% | 53% | |
| C-330 | | | | | | | | | | | | | | |
| Grilon BM | 5% | 5% | 10% | 10% | 10% | 10% | 10% | | 15% | 15% | 5% | 12% | 12% | |
| 13 SBG | | | | | | | | | | | | | | |
| Mazmid | | | | | | | | | | | | | | |
| B-370 | | | | | | | | | | | | | | |
| Terpalex | | | | | | | | | | 50% | | | | |
| 6434 B | | | | | | | | | | | | | | |
| Grilon BM | | | | | | | | | 50% | | | | | |
| 17 SBG | | | | | | | | | | | | | | |
| TD Shrink | 42.3% | 52.4% | 38.0% | 40.8% | 41.8% | 40.8% | 49.6% | 31.3% | 49.3% | 55.7% | 19.5% | 40.2% | 41.3% | |
| MD Shrink | 33.7% | 37.5% | 34.7% | 30.6% | 36.3% | 36.7% | 34.7% | 23.7% | 43.9% | 40.7% | 15.7% | 26.9% | 31.2% | |
| Tape | 260μ | 260μ | 260μ | 260μ | 260μ | 260μ | 260μ | 260μ | 260μ | 260μ | 260μ | 260μ | 260μ | |
| Thickness | | | | | | | | | | | | | | |

M - Structure: (outer)/EVA/Tie/Nylon/EVOH/Nylon/Tie/EVA/(inner) [20/12/11/6/11/12/28%] (7-layer) - Water Quench
N - Structure: (outer)/EVA/Tie/Nylon/EVOH/Nylon/Tie/EVA/(inner) [20/12/6/6/16/12/28%] (7-layer) - Water Quench

In Table 1, all of the examples were processed by air-cooled 5-layer extrusion. In Tables 2-5, all of the examples were processed by water-quenched 7-layer extrusion. Thus, the examples illustrate that the respective blend compositions of the invention can be processed by either air-cooled or water-quench processes.

While the examples illustrate using the invention in 5-layer films and 7-layer films, the nylon blend compositions and EVOH blend compositions of the invention can be employed in films having any desired number of layers, as generally illustrated in the drawing FIGURES.

Those skilled in the art will now see that certain modifications can be made to the apparatus and methods herein disclosed with respect to the illustrated embodiments, without departing from the spirit of the instant invention. And while the invention has been described above with respect to the preferred embodiments, it will be understood that the invention is adapted to numerous rearrangements, modifications, and alterations, and all such arrangements, modifications, and alterations are intended to be within the scope of the appended claims.

To the extent the following claims use means plus function language, it is not meant to include there, or in the instant specification, anything not structurally equivalent to what is shown in the embodiments disclosed in the specification.

Having thus described the invention, what is claimed is:

1. A multiple layer polymeric film, comprising:
(a) a first nylon layer, comprising one or more nylon polymers;
(b) a second nylon layer, comprising one or more nylon polymers; and
(c) a third layer comprising at least 40 percent by weight ethylene vinyl alcohol copolymer, said third layer being disposed between said first and second layers,
wherein at least one of said first and second nylon layers comprises,
(i) as a first component, about 15 percent by weight to about 65 percent by weight amorphous nylon,
(ii) as a second component, about 5 percent by weight to about 50 percent by weight of a relatively lower melting temperature semi-crystalline nylon composition, having an effective melting temperature of less than 170 degrees C., and
(iii) as a third component, about 10 percent by weight to about 55 percent by weight of a relatively higher melting temperature semi-crystalline nylon composition, having an effective melting temperature of at least 145 degrees C., and at least 10 degrees C. greater than the melting temperature of said second component.

2. A multiple layer polymeric film as in claim 1 wherein at least one of said first and second nylon layers comprises,
(i) as a first component, about 15 percent by weight to about 65 percent by weight amorphous nylon,
(ii) as a second component, about 5 percent by weight to about 35 percent by weight of a relatively lower melting temperature semi-crystalline nylon composition, having an effective melting temperature of less than 170 degrees C., and
(iii) as a third component, about 30 percent by weight to about 55 percent by weight of a relatively higher melting temperature semi-crystalline nylon composition, having an effective melting temperature of at least 145 degrees C., and at least 10 degrees C. greater than the melting temperature of said second component.

3. A multiple layer polymeric film as in claim 1 wherein at least one of said first and second nylon layers comprises,
(i) as a first component, about 20 percent by weight to about 55 percent by weight amorphous nylon,
(ii) as a second component, about 10 percent by weight to about 30 percent by weight of a relatively lower melting temperature semi-crystalline nylon composition, having an effective melting temperature of less than 170 degrees C., and
(iii) as a third component, about 40 percent by weight to about 55 percent by weight of a relatively higher melting temperature semi-crystalline nylon composition, having an effective melting temperature of at least 145 degrees C., and at least 10 degrees C. greater than the melting temperature of said second component.

4. A multiple layer polymeric film as in claim 1 wherein at least one of said first and second nylon layers comprises,
(i) as a first component, about 25 percent by weight to about 40 percent by weight amorphous nylon,
(ii) as a second component, about 12 percent by weight to about 20 percent by weight of a relatively lower melting temperature semi-crystalline nylon composition, having an effective melting temperature of less than 170 degrees C., and
(iii) as a third component, about 45 percent by weight to about 55 percent by weight of a relatively higher melting temperature semi-crystalline nylon composition, having an effective melting temperature of at least 145 degrees C., and at least 10 degrees C. greater than the melting temperature of said second component.

5. A multiple layer polymeric film as in claim 1 wherein at least one of said first and second nylon layers comprises,
(i) as a first component, greater than 30 percent by weight and up to about 40 percent by weight amorphous nylon,
(ii) as a second component, about 10 percent by weight to about 25 percent by weight of a relatively lower melting temperature semi-crystalline nylon composition, having an effective melting temperature of less than 170 degrees C., and
(iii) as a third component, about 40 percent by weight to about 55 percent by weight of a relatively higher melting temperature semi-crystalline nylon composition, having an effective melting temperature of at least 145 degrees C., and at least 10 degrees C. greater than the melting temperature of said second component.

6. A multiple layer polymeric film as in claim 5 wherein said second component of said at least one of said first and second nylon layers comprises nylon 6/69 and/or nylon 6/12.

7. A multiple layer polymeric film as in claim 6 wherein said third component, of said at least one of said first and second nylon layers, comprises a polyamide selected from the group consisting of nylon 6, nylon 6/66, nylon 6/12, and functionally effective terpolymers comprising moieties derived from nylon 6, nylon 66, nylon 69, nylon 12, nylon MXD6, nylon MXD10, and nylon 6I amide moieties.

8. A multiple layer polymeric film as in claim 1 wherein said ethylene vinyl alcohol copolymer in said third layer comprises a stretchable grade ethylene vinyl alcohol copolymer and wherein said stretchable grade ethylene vinyl alcohol copolymer is present in an amount which represents at least 50 percent by weight of all of the ethylene vinyl alcohol copolymer which is present in said third layer.

9. A multiple layer polymeric film as in claim 3 wherein said ethylene vinyl alcohol copolymer in said third layer comprises a stretchable grade ethylene vinyl alcohol copolymer and wherein said stretchable grade ethylene vinyl alcohol copolymer is present in an amount which represents at least 50 percent by weight of all of the ethylene vinyl alcohol copolymer which is present in said third layer.

10. A multiple layer polymeric film as in claim 1 wherein said ethylene vinyl alcohol copolymer in said third layer is a stretchable grade ethylene vinyl alcohol copolymer, wherein said third layer further comprises, as a second component, 10 percent by weight to 40 percent by weight semi-crystalline nylon 6/69 and/or nylon 6/12 having effective melting temperature of no more than 155 degrees C., and wherein said first and second layers are functionally devoid of any nylon 6/69 or nylon 6/12 having melting temperature of less than 170 degrees C., said film being oriented so as to exhibit at least 28 percent shrink in at least one of a machine direction and a transverse direction when exposed to 90 degrees C. for 2 seconds.

11. A multiple layer polymeric film as in claim 1 wherein said ethylene vinyl alcohol copolymer in said third layer is a stretchable grade ethylene vinyl alcohol copolymer, wherein said third layer further comprises, as a second component, about 10 percent by weight to about 40 percent by weight semi-crystalline nylon 6/69 and/or nylon 6/12 having effective melting temperature of less than 170 degrees C., and wherein each of said first and second layers comprises,
(i) as a first component, about 20 percent by weight to about 55 percent by weight amorphous nylon,
(ii) as a second component, about 10 percent by weight to about 30 percent by weight of a first semi-crystalline nylon composition having a melting temperature of less than 170 degrees C., and
(iii) as a third component, about 40 percent by weight to about 55 percent by weight of a second semi-crystalline nylon composition having a melting temperature greater than 145 degrees C. and at least 10 degrees C. greater than the melting temperature of said first nylon composition, said film being oriented so as to exhibit at least 28 percent shrink in at least one of a machine direction and a transverse direction when exposed to 90 degrees C. for 2 seconds.

12. A multiple layer polymeric film as in claim 1, said multiple layer film further comprising a fourth outer layer defining a first outer surface of said film, and a fifth outer layer defining a second opposing outer surface of said film, wherein each of said first, second, and third layers is disposed between said fourth and fifth layers.

13. A multiple layer polymeric film as in claim 12, further comprising a sixth layer between said fourth outer layer and said first nylon layer, and a seventh layer between said fifth outer layer and said second nylon layer.

14. A multiple layer polymeric film as in claim 1 wherein semi-crystalline nylon is present in said first, second, and/or third layers, collectively, in sufficient capacity to accommodate said film being biaxially oriented so as to thereby have a shrink capacity of at least 28 percent in at least one of a machine direction and a transverse direction when exposed to 90 degrees C. for 2 seconds.

15. A multiple layer polymeric film as in claim 1 wherein semi-crystalline nylon is present in said first, second, and/or third layers, collectively, in sufficient capacity to accommodate said film being biaxially oriented so as to thereby have a shrink capacity of at least 44 percent in at least one of a machine direction and a transverse direction when exposed to 90 degrees C. for 2 seconds.

16. A multiple layer polymeric film, comprising:
(a) a first nylon layer, comprising one or more nylon polymers;
(b) a second nylon layer, comprising one or more nylon polymers; and
(c) a third layer comprising at least 40 percent by weight ethylene vinyl alcohol copolymer, said third layer being disposed between said first and second layers,
wherein at least one of said first, second, and third layers comprises greater than 30 percent by weight to about 65 percent by weight amorphous polyamide, and less than 70 percent by weight to about 35 percent by weight semi-crystalline nylon selected from the group consisting of nylon 6 homopolymers; nylon 6/66 copolymers; nylon 6/12 copolymers; nylon 6/69 copolymers; terpolymers comprising moieties of at least one of nylon 6, nylon 66, nylon 12, nylon 6I, nylon 69; nylon MXD6, and nylon MXD10, and blends of said homopolymers, copolymers, and terpolymers.

17. A multiple layer film as in claim 16 wherein said third layer comprises, as a first semi-crystalline nylon composition, about 5 percent by weight to about 50 percent by weight of a nylon composition having an effective melting temperature of less than 170 degrees C.

18. A multiple layer film as in claim 16 wherein said third layer comprises, as a first semi-crystalline nylon composition, about 5 percent by weight to about 35 percent by weight of a nylon composition having an effective melting temperature of less than 170 degrees C.

19. A multiple layer film as in claim 16 wherein said third layer comprises, as a first semi-crystalline nylon, about 10 percent by weight to about 30 percent by weight of a nylon composition having an effective melting temperature of less than 170 degrees C.

20. A multiple layer film as in claim 16 wherein said third layer comprises, as a first semi-crystalline nylon, about 10 percent by weight to about 20 percent by weight of a nylon composition having an effective melting temperature of less than 170 degrees C.

21. A multiple layer film as in claim 16 wherein said ethylene vinyl alcohol copolymer in said third layer comprises a stretchable grade ethylene vinyl alcohol copolymer and wherein said stretchable grade ethylene vinyl alcohol copolymer is present in an amount which represents at least 50 percent by weight of all of the ethylene vinyl alcohol copolymer which is present in said third layer.

22. A multiple layer film as in claim 16 wherein said ethylene vinyl alcohol copolymer in said third layer is a stretchable grade ethylene vinyl alcohol copolymer, wherein said third layer further comprises, as a second component, about 10 percent by weight to about 40 percent by weight nylon 6/69 and/or nylon 6/12 having effective melting temperature of less than 170 degrees C., and wherein said first and second layers are functionally devoid of respective nylon 6/69 and/or nylon 6/12 having melting temperature of less than 170 degrees C., said film being oriented so as to exhibit at least 28 percent shrink in at least one of a machine direction and a transverse direction when exposed to 90 degrees C. for 2 seconds.

23. A multiple layer film as in claim 16 wherein said ethylene vinyl alcohol copolymer in said third layer is a stretchable grade ethylene vinyl alcohol copolymer, wherein said third layer further comprises, as a second component, about 10 percent by weight to about 40 percent by weight semi-crystalline nylon 6/69 and/or nylon 6/12 having effective melting temperature of less than 170 degrees C., and wherein each of said first and second layers comprises,
(i) as a first component, about 20 percent by weight to about 55 percent by weight amorphous nylon,
(ii) as a second component, about 10 percent by weight to about 30 percent by weight of a first semi-crystalline nylon composition having a melting temperature of less than 170 degrees C., and
(iii) as a third component, about 40 percent by weight to about 55 percent by weight of a second semi-crystalline nylon composition having a melting temperature greater than 145 degrees C. and at least 10 degrees C. greater than the melting temperature of said first nylon composition, said film being oriented so as to exhibit at least 28 percent shrink in at least on of a machine direction and a transverse direction when exposed to 90 degrees C. for 2 seconds.

24. A multiple layer film as in claim 23, said multiple layer film further comprising a fourth outer layer defining a first outer surface of said film, and a fifth outer layer defining a second opposing outer surface of said film, wherein each of said first, second, and third layers is disposed between said fourth and fifth layers.

25. A multiple layer film as in claim 16 wherein semi-crystalline nylon is present in said first, second, and/or third layers, collectively, in sufficient capacity to accommodate said film being biaxially oriented so as to thereby have a shrink capacity of at least 28 percent in at least one of a machine direction and a transverse direction when exposed to 90 degrees C. for 2 seconds.

26. A multiple layer film as in claim 16 wherein semi-crystalline nylon is present in said first, second, and/or third layers, collectively, in sufficient capacity to accommodate said film being biaxially oriented so as to thereby have a shrink capacity of at least 44 percent in at least one of a machine direction and a transverse direction when exposed to 90 degrees C. for 2 seconds.

27. A multiple layer film as in claim 16 wherein greater than 30 percent by weight to about 40 percent by weight of at least one of said first and second layers is defined by said amorphous polyamide, and less than 70 percent by weight to about 60 percent by weight of said at least one layer is defined by said semi-crystalline nylon.

28. A polymeric film, comprising:
(a) a first nylon layer, said first nylon layer comprising
(i) about 15 percent by weight to about 65 percent by weight amorphous polyamide, and
(ii) about 35 percent by weight to about 85 percent by weight semi-crystalline nylon, said semi-crystalline nylon comprising, based on total weight of said first nylon layer,
A. about 5 percent by weight to about 50 percent by weight of a relatively lower melting temperature first semi-crystalline nylon composition having a melting temperature of less than 170 degrees C., and
B. about 10 percent by weight to about 55 percent by weight of a relatively higher melting temperature second semi-crystalline nylon composition, having a melting temperature greater than 145 degrees C. and at least 10 degrees C. greater than the melting temperature of said first semi-crystalline nylon composition; and
(b) a second ethylene vinyl alcohol layer, said second layer comprising at least 40 percent by weight ethylene vinyl alcohol copolymer.

29. A polymeric film as in claim 28 wherein said polymeric film is biaxially oriented.

30. A biaxially oriented polymeric film as in claim 29 wherein said biaxially oriented polymeric film is a biaxially oriented tubular polymeric film.

31. A biaxially oriented tubular polymeric film as in claim 30 wherein said first nylon layer comprises about 20 percent by weight to about 55 percent by weight amorphous nylon and about 80 percent by weight to about 45 percent by weight of said semi-crystalline nylon composition.

32. A biaxially oriented tubular polymeric film as in claim 30 wherein said first nylon layer comprises greater than 30 percent by weight up to about 40 percent by weight amorphous nylon and less than 70 percent by weight up to about 60 percent by weight of said semi-crystalline nylon composition.

33. A biaxially oriented tubular polymeric film as in claim 30 wherein said second ethylene vinyl alcohol layer comprises, in blend composition, about 5 percent by weight to about 50 percent by weight nylon 6/69 and/or nylon 6/12.

34. A biaxially oriented tubular polymeric film as in claim 30 wherein said second ethylene vinyl alcohol layer comprises, in blend composition, about 5 percent by weight up to about 30 percent by weight nylon 6/69 and/or nylon 6/12.

35. A biaxially oriented tubular polymeric film as in claim 31 wherein said second ethylene vinyl alcohol layer comprises, in blend composition, about 10 percent by weight up to about 30 percent by weight nylon 6/69 and/or nylon 6/12.

36. A biaxially oriented tubular polymeric film as in claim 32 wherein said first layer comprises, in blend composition, about 10 percent by weight up to about 25 percent by weight nylon 6/69 and/or nylon 6/12.

37. A biaxially oriented tubular polymeric film as in claim 30, said semi-crystalline nylon composition being present in said first layer in sufficient capacity to accommodate said biaxially oriented film having a shrink capacity of at least 28 percent shrink, in at least one of a machine direction and a transverse direction, when exposed to 90 degrees C. for 2 seconds.

38. A biaxially oriented tubular polymeric film as in claim 31, said semi-crystalline nylon composition being present in said second layer in sufficient capacity to accommodate said biaxially oriented film having a shrink capacity of at least 28 percent shrink, in at least one of a machine direction and a transverse direction, when exposed to 90 degrees C. for 2 seconds.

39. A biaxially oriented tubular polymeric film as in claim 30 wherein said ethylene vinyl alcohol copolymer in said second layer comprises at least 50 percent by weight stretchable grade ethylene vinyl alcohol copolymer.

40. A biaxially oriented tubular polymeric film as in claim 31 wherein said ethylene vinyl alcohol copolymer in said second layer comprises at least 50 percent by weight stretchable grade ethylene vinyl alcohol copolymer.

41. A biaxially oriented tubular polymeric film as in claim 28, further comprising a third tie layer, and a fourth layer, said tie layer being disposed between said second layer and said fourth layer, and wherein said ethylene vinyl alcohol copolymer in said second layer comprises at least 90 percent by weight stretchable grade ethylene vinyl alcohol copolymer.

42. A biaxially oriented tubular polymeric film as in claim 41, said ethylene vinyl alcohol copolymer layer being disposed between said tie layer and said first nylon layer.

43. A biaxially oriented tubular polymeric film as in claim 42, further comprising a fifth layer, said first layer being disposed between said fifth layer and said second layer, said fourth and fifth layers comprising ethylene vinyl acetate compositions.

44. A biaxially oriented tubular polymeric film as in claim 43 wherein said second layer comprises, in blend composition, about 20 percent by weight to about 25 percent by weight of a nylon composition having an effective melting temperature of no more than about 145 degrees C.

45. A biaxially oriented tubular polymeric film as in claim 43, further comprising sixth and seventh polyolefinic layers, said fourth layer being disposed between said second layer and said sixth layer, said fifth layer being disposed between said second layer and said seventh layer.

46. A biaxially oriented tubular polymeric film as in claim 32 wherein about 40 percent by weight to about 55 percent by weight of said semi-crystalline nylon is defined by said relatively higher melting temperature semi-crystalline nylon composition, and wherein about 15 percent by weight to 100 percent by weight of said relatively higher melting temperature nylon composition is defined by nylon terpolymer.

47. A biaxially oriented polymeric film as in claim 29, said semi-crystalline nylon comprising, as said relatively lower melting temperature first semi-crystalline nylon composition, nylon 6/69.

48. A biaxially oriented polymeric film as in claim 47 wherein said first nylon layer comprises
(i) about 15 percent by weight to about 65 percent by weight amorphous polyamide,
(ii) about 5 percent by weight to about 35 percent by weight of said nylon 6/69, and
(iii) about 30 percent by weight to about 55 percent by weight of said relatively higher melting temperature second semi-crystalline nylon composition.

49. A biaxially oriented polymeric film as in claim 47 wherein said first nylon layer comprises
(i) about 20 percent by weight to about 55 percent by weight amorphous polyamide,
(ii) about 10 percent by weight to about 30 percent by weight of said nylon 6/69, and
(iii) about 40 percent by weight to about 55 percent by weight of said relatively higher melting temperature second semi-crystalline nylon composition.

50. A biaxially oriented polymeric film as in claim 47 wherein said first nylon layer comprises
(i) about 25 percent by weight to about 40 percent by weight amorphous polyamide,
(ii) about 12 percent by weight to about 20 percent by weight of said nylon 6/69, and
(iii) about 45 percent by weight to about 55 percent by weight of said relatively higher melting temperature second semi-crystalline nylon composition.

51. A biaxially oriented polymeric film as in claim 47 wherein said first nylon layer comprises
(i) greater than 30 percent by weight to about 40 percent by weight amorphous polyamide,
(ii) about 10 percent by weight to about 25 percent by weight of said nylon 6/69, and
(iii) about 40 percent by weight to about 55 percent by weight of said relatively higher melting temperature second semi-crystalline nylon composition.

52. A biaxially oriented polymeric film as in claim 47, said biaxially oriented polymeric film having a shrink capacity, in at least one of a machine direction and a transverse direction, of at least 35 percent when exposed to 90 degrees C. for 2 seconds.

53. A biaxially oriented polymeric film as in claim 48, said biaxially oriented polymeric film having a shrink capacity, in at least one of a machine direction and a transverse direction, of at least 35 percent when exposed to 90 degrees C. for 2 seconds.

54. A biaxially oriented polymeric film as in claim 49, said biaxially oriented polymeric film having a shrink capacity, in at least one of a machine direction and a transverse direction, of at least 44 percent when exposed to 90 degrees C. for 2 seconds.

55. A biaxially oriented polymeric film as in claim 50, said biaxially oriented polymeric film having a shrink capacity, in at least one of a machine direction and a transverse direction, of at least 44 percent when exposed to 90 degrees C. for 2 seconds.

56. A biaxially oriented polymeric film as in claim 52, said biaxially oriented polymeric film having a shrink capacity, in at least one of a machine direction and a transverse direction, of at least 50 percent when exposed to 90 degrees C. for 2 seconds.

57. A biaxially oriented polymeric film as in claim 49 wherein about 15 percent by weight to about 100 percent by weight of said relatively higher melting temperature second semi-crystalline nylon component is defined by nylon terpolymer.

58. A polymeric shrink film, comprising:
(a) a first nylon layer, said first nylon layer comprising
(i) about 15 percent by weight to about 65 percent by weight amorphous polyamide,
(ii) as a first semi-crystalline nylon component, about 5 percent by weight to about 50 percent by weight of a relatively lower melting temperature first semi-crystalline nylon composition, having a melting temperature of less than 170 degrees C., and
(iii) as a second semi-crystalline nylon component, about 10 percent by weight to about 55 percent by weight of a relatively higher melting temperature second semi-crystalline nylon composition having a melting temperature of greater than 145 degrees C. and at least 10 degrees greater than the melting temperature of said first semi-crystalline nylon composition; and
(b) a second layer comprising at least 40 percent by weight ethylene vinyl alcohol copolymer, said biaxially oriented polymeric film having a shrink capacity, in at least one of a machine direction and a transverse direction, of at least 35 percent when exposed to 90 degrees C. for 2 seconds.

59. A polymeric shrink film as in claim 58 wherein said shrink film has a shrink capacity, in at least one of the machine direction and the transverse direction, of at least 44 percent when exposed to 90 degrees C. for 2 seconds.

60. A polymeric shrink film as in claim 58 wherein said shrink film has a shrink capacity, in at least one of the machine direction and the transverse direction, of at least 50 percent when exposed to 90 degrees C. for 2 seconds.

61. A polymeric shrink film as in claim 58 wherein said first nylon layer comprises
(i) about 20 percent by weight to about 55 percent by weight amorphous polyamide,
(ii) about 10 percent by weight to about 30 percent by weight of said first semi-crystalline nylon component, and
(iii) about 30 percent by weight to about 55 percent by weight of said second semi-crystalline nylon component.

62. A polymeric shrink film as in claim 59 wherein said first nylon layer comprises
(i) about 20 percent by weight to about 55 percent by weight amorphous polyamide,
(ii) about 10 percent by weight to about 30 percent by weight of said first semi-crystalline nylon component, and
(iii) about 30 percent by weight to about 55 percent by weight of said second semi-crystalline nylon component.

63. A polymeric shrink film as in claim 58 wherein said first nylon layer comprises
(i) greater than 30 percent by weight up to about 55 percent by weight amorphous polyamide,
(ii) about 10 percent by weight to about 25 percent by weight of said relatively lower melting temperature second semi-crystalline nylon, and
(iii) about 30 percent by weight to about 55 percent by weight of said relatively higher melting temperature first semi-crystalline nylon.

64. A polymeric shrink film as in claim 59 wherein said first nylon layer comprises
(i) greater than 30 percent by weight up to about 55 percent by weight amorphous polyamide,
(ii) about 10 percent by weight to about 25 percent by weight of said first semi-crystalline nylon component, and
(iii) about 30 percent by weight to about 55 percent by weight of said second semi-crystalline nylon component.

65. A polymeric shrink film as in claim 58 wherein said second ethylene vinyl alcohol layer comprises
(i) about 60 percent by weight up to about 90 percent by weight ethylene vinyl alcohol copolymer, and
(ii) about 40 percent by weight to about 10 percent by weight of nylon 6/69 and/or nylon 6/12, such nylon 6/12 having a melting temperature of less than 170 degrees C.

66. A polymeric shrink film as in claim 59 wherein said second ethylene vinyl alcohol layer comprises
(i) about 60 percent by weight up to about 90 percent by weight ethylene vinyl alcohol copolymer, and
(ii) about 40 percent by weight to about 10 percent by weight of nylon 6/69 and/or nylon 6/12, such nylon 6/12 having a melting temperature of less than 170 degrees C.

67. A polymeric shrink film as in claim 61 wherein about 15 percent by weight to 100 percent by weight of said relatively higher melting temperature second semi-crystalline nylon composition is defined by nylon terpolymer.

68. A coextruded multiple layer polymeric film, comprising:
(a) a first ethylene vinyl alcohol copolymer layer comprising
(i) as a first component, about 60 percent by weight to about 95 percent by weight ethylene vinyl alcohol copolymer, and
(ii) as a second component, about 40 percent by weight to about 5 percent of a semi-crystalline nylon composition; and
(b) at least a second polymeric layer which is functionally devoid of ethylene vinyl alcohol copolymer,
said multiple layer film being biaxially oriented, having a shrink capacity of at least 30 percent in at least one of a machine direction and a transverse direction when exposed to 90 degrees C. for 2 seconds, the shrink capacity of said multiple layer film being at least 3 percentage points greater than shrink capacity of a corresponding film wherein said first layer consists essentially of the same said ethylene vinyl alcohol copolymer.

69. A coextruded multiple layer polymeric film as in claim 68 wherein said semi-crystalline nylon is present in an amount of about 10 percent by weight to about 30 percent by weight.

70. A coextruded multiple layer polymeric film as in claim 68 wherein said semi-crystalline nylon comprises nylon 6/69 and/or nylon 6/12 and has a melting temperature of less than 145 degrees C.

71. A coextruded multiple layer polymeric film as in claim 69 wherein said semi-crystalline nylon comprises nylon 6/69 and/or nylon 6/12 and has a melting temperature of less than 145 degrees C.

72. A coextruded multiple layer polymeric film as in claim 68 wherein said film is biaxially oriented, and has an overall shrink capacity of at least 35 percent and up to about 55 percent in at least one of a machine direction and a transverse direction, when exposed to 90 degrees C. for 2 seconds.

73. A coextruded multiple layer polymeric film as in claim 70 wherein said film is biaxially oriented, and has an overall shrink capacity of at least 35 percent up to about 55 percent in at least one of a machine direction and a transverse direction, when exposed to 90 degrees C. for 2 seconds.

74. A coextruded multiple layer polymeric film as in claim 72 wherein said ethylene vinyl alcohol copolymer is stretchable grade ethylene vinyl alcohol copolymer.

75. A coextruded multiple layer polymeric film as in claim 73 wherein said ethylene vinyl alcohol copolymer is stretchable grade ethylene vinyl alcohol copolymer.

76. A coextruded multiple layer polymeric film as in claim 68, further comprising a third layer, said second and third layers comprising olefin-based layers and being disposed on opposing sides of said first ethylene vinyl alcohol copolymer layer.

77. A coextruded multiple layer polymeric film as in claim 68 wherein said second component has a melting temperature of less than 145 degrees C. and comprises nylon 6/69 and/or nylon 6/12.

78. A coextruded multiple layer polymeric film as in claim 68 wherein about 15 percent by weight to 100 percent by weight of said ethylene vinyl alcohol copolymer layer is defined by nylon terpolymer.

79. A coextruded multiple layer polymeric film as in claim 78, said multiple layer polymeric film having a shrink capacity of at least 35 percent in at least one of the machine direction and the transverse direction when exposed to 90 degrees C. for 2 seconds.

80. A coextruded multiple layer polymeric film as in claim 68, said multiple layer polymeric film having a shrink capacity of at least 35 percent in at least one of the machine direction and the transverse direction when exposed to 90 degrees C. for 2 seconds.

81. A polymeric shrink film, comprising:
(a) a first layer comprising at least predominantly nylon; and
(b) a second ethylene vinyl alcohol layer comprising
(i) 40 percent by weight to 100 percent by weight ethylene vinyl alcohol copolymer, and
(ii) from zero percent by weight to 60 percent by weight of a semi-crystalline nylon composition, said semi-crystalline nylon composition, when present, comprising, as a first semi-crystalline nylon, an effective amount of nylon 6/69 and/or nylon 6/12 having melting temperature of less than 170 degrees C.,
said shrink film having a shrink capacity, in at least on of a machine direction and a transverse direction, of at least 44 percent shrink when exposed to 90 degrees C. for 2 seconds.

82. A polymeric shrink film as in claim 81, said semi-crystalline nylon composition further comprising an effective amount of a second semi-crystalline nylon which is not nylon 6/69 and which has a melting temperature at least 10 degrees higher than the melting temperature of said first semi-crystalline nylon.

83. A biaxially oriented polymeric film as in claim 81 wherein said second ethylene vinyl alcohol layer comprises 60 percent by weight to 90 percent by weight ethylene vinyl alcohol copolymer, and 40 percent by weight to 10 percent by weight said semi-crystalline nylon composition.

84. A biaxially oriented polymeric film as in claim 81 wherein said second ethylene vinyl alcohol layer comprise 65 percent by weight to 85 percent by weight said ethylene vinyl alcohol copolymer and 35 percent by weight to 15 percent by weight said semi-crystalline nylon composition.

85. A biaxially oriented polymeric film as in claim 81 wherein said ethylene vinyl alcohol copolymer is a stretchable grade ethylene vinyl alcohol copolymer.

86. A biaxially oriented polymeric film as in claim 82 wherein said ethylene vinyl alcohol copolymer is a stretchable grade ethylene vinyl alcohol copolymer.

87. A biaxially oriented polymeric film as in claim 81 wherein the composition of said first layer is compatible with sufficient biaxial orienting, and wherein said semi-crystalline nylon composition is present in said second layer in sufficient capacity to accommodate said second layer being sufficiently biaxially oriented, that said biaxially oriented film has a shrink capacity of greater than 28 percent and up to about 55 percent, in at least one of a machine direction and a transverse direction, when exposed to 90 degrees C. for 2 seconds.

88. A biaxially oriented polymeric film as in claim 82 wherein the composition of said first layer is compatible with sufficient biaxial orienting, and wherein said semi-crystalline nylon composition is present in said second layer in sufficient capacity to accommodate said second layer being sufficiently biaxially oriented, that said biaxially oriented film has a shrink capacity of greater than 28 percent and up to about 55 percent, in at least one of a machine direction and a transverse direction, when exposed to 90 degrees C. for 2 seconds.

89. A biaxially oriented polymeric film as in claim 81, said first layer comprising about 20 percent by weight to about 50 percent by weight amorphous nylon, about 10 percent by weight to about 30 percent by weight of a relatively lower melting temperature nylon composition having a melting temperature of less than 145 degrees C., and about 40 percent by weight to about 65 percent by weight of a relatively higher melting temperature nylon composition having a melting temperature of at least 145 degrees C., and wherein about 15 percent by weight to 100 percent by weight of said relatively higher melting temperature nylon composition is defined by nylon terpolymer.

90. A composition of matter, comprising:
(a) 15 percent by weight to 65 percent by weight amorphous nylon;
(b) as a first semi-crystalline nylon component, about 5 percent by weight to about 50 percent by weight nylon 6/69; and
(c) as a second semi-crystalline nylon component, about 10 percent by weight to about 55 percent by weight of a nylon composition having a melting temperature of greater than 145 degrees C. and at least 10 degrees C. greater than the melting temperature of said first semi-crystalline nylon component.

91. A composition as in claim 90 wherein
said amorphous nylon is present in an amount of 15 percent by weight to 45 percent by weight,
said nylon 6/69 is present in an amount of about 5 percent by weight to about 35 percent by weight, and
said second semi-crystalline nylon component is present in an amount of about 30 percent by weight to 55 percent by weight.

92. A composition as in claim 90 wherein
said amorphous nylon is present in an amount of 20 percent by weight to 55 percent by weight,
said nylon 6/69 is present in an amount of about 10 percent by weight to about 30 percent by weight, and
said second semi-crystalline nylon component is present in an amount of about 40 percent by weight to about 55 percent by weight.

93. A composition as in claim 90 wherein
said amorphous nylon is present in an amount of about 25 percent by weight to about 40 percent by weight,
said nylon 6/69 is present in an amount of about 10 percent by weight to about 20 percent by weight, and
said second semi-crystalline nylon component is present in an amount of about 45 percent by weight to about 55 percent by weight.

94. An extruded polymeric film comprising a layer made with a composition of claim 90.

95. An extruded polymeric film comprising a layer made with a composition of claim 91.

96. An extruded polymeric film comprising a layer made with a composition of claim 92.

97. An extruded polymeric film comprising a layer made with a composition of claim 93.

98. A biaxially oriented polymeric film made with a composition as in claim 91, said biaxially oriented polymeric film having a shrink capacity, in at least one of a machine direction and a transverse direction, of at least 44 percent when exposed to 90 degrees C. for 2 seconds.

99. A biaxially oriented polymeric film made with a composition as in claim 92 wherein about 15 percent by weight to 100 percent by weight of said second semi-crystalline component is defined by nylon terpolymer.

100. A composition of matter, comprising:
(a) about 15 percent by weight to about 65 percent by weight amorphous nylon;
(b) as a first semi-crystalline nylon, at least 18 percent by weight to about 50 percent by weight of a first relatively lower melting temperature semi-crystalline nylon composition which has a melting temperature of less than 170 degrees C.; and
(c) as a second semi-crystalline nylon, about 10 percent by weight to about 55 percent by weight of a relatively higher melting temperature second semi-crystalline nylon composition, which is not nylon 6, and which has a melting temperature greater than 145 degrees C. and at least 10 degrees C. greater than the melting temperature of said first semi-crystalline nylon composition.

101. A composition as in claim 100 wherein
said amorphous nylon is present in an amount of about 15 percent by weight to about 55 percent by weight,
said first semi-crystalline nylon is present in an amount of at least 18 percent by weight up to about 35 percent by weight, and
said second semi-crystalline nylon is present in an amount of about 30 percent by weight to about 55 percent by weight.

102. A composition as in claim 100 wherein
said amorphous nylon is present in an amount of about 20 percent by weight to about 55 percent by weight,
said first semi-crystalline nylon is present in an amount of at least 18 percent by weight up to about 30 percent by weight, and
said second semi-crystalline nylon is present in an amount of about 40 percent by weight to about 55 percent by weight.

103. A composition as in claim 100 wherein
said amorphous nylon is present in an amount of greater than 30 percent by weight up to about 40 percent by weight,
said first semi-crystalline nylon is present in an amount of at least 18 percent by weight to about 30 percent by weight, and
said second semi-crystalline nylon is present in an amount of about 45 percent by weight to about 55 percent by weight.

104. An extruded polymeric film made with a composition of claim 100.

105. An extruded polymeric film made with a composition of claim 101.

106. An extruded polymeric film made with a composition of claim 102.

107. An extruded polymeric film made with a composition of claim 103.

108. A composition of matter, comprising:
(a) as a first component, greater than 30 percent by weight to 65 percent by weight amorphous nylon;
(b) as a second component, 35 percent by weight to less than 70 percent by weight of a polymer composition comprising first and second semi-crystalline nylons, said first semi-crystalline nylon comprising nylon 6/69, said nylon 6/69 comprising at least 5 percent by weight of said second component.

109. A composition as in claim 108 wherein
said amorphous nylon is present in an amount of greater than 30 percent by weight up to 40 percent by weight;
said nylon 6/69 is present in an amount of about 10 percent by weight to about 30 percent by weight, and
said second semi-crystalline nylon is present in an amount of about 40 percent by weight to about 55 percent by weight.

110. An extruded polymeric film made with a composition of claim 108.

111. An extruded polymeric film made with a composition of claim 109.

112. A biaxially oriented polymeric film having at least one layer made with a composition of claim 108, said biaxially oriented polymeric film having a shrink capacity, in at least one of a machine direction and a transverse direction, of at least 44 percent when exposed to 90 degrees C. for 2 seconds.

113. A composition of matter, comprising:
(a) 15 percent by weight to 65 percent by weight amorphous nylon;
(b) as a first semi-crystalline nylon component, about 5 percent by weight to about 50 percent by weight of a relatively lower melting temperature semi-crystalline nylon composition, having an effective melting temperature of less than 170 degrees C.; and
(c) as a second semi-crystalline nylon component, about 10 percent by weight to about 65 percent by weight of a relatively higher melting temperature semi-crystalline nylon composition, having an effective melting temperature of at least 145 degrees C., and at least 10 degrees C. greater than the melting temperature of said first semi-crystalline nylon component, and wherein about 15 percent by weight to 100 percent by weight of said second semi-crystalline nylon component is defined by nylon terpolymer.

114. A composition of matter as in claim 113, comprising about 20 percent by weight to about 50 percent by weight of said amorphous nylon, about 10 percent by weight to about 30 percent by weight of said relatively lower melting temperature semi-crystalline nylon, and about 40 percent by weight to about 65 percent by weight of said relatively higher melting temperature semi-crystalline nylon.

115. A composition of matter as in claim 113, comprising about 30 percent by weight to about 40 percent by weight of said amorphous nylon, about 10 percent by weight to about 20 percent by weight of said relatively lower melting temperature semi-crystalline nylon, and about 50 percent by weight to about 65 percent by weight of said relatively higher melting temperature semi-crystalline nylon.

116. A composition of matter as in claim 113 wherein said nylon terpolymer comprises nylon terpolymer selected from the group consisting of nylon 6/66/12, nylon 6/69/6I, I, nylon 66/69/6I, and nylon 66/610/MXD6.

117. A composition of matter as in claim 114 wherein said nylon terpolymer comprises nylon terpolymer selected from the group consisting of nylon 6/66/12, nylon 6/69/6I, nylon 66/69/6I, and nylon 66/610/MXD6.

118. A composition of matter as in claim 115 wherein said nylon terpolymer comprises nylon terpolymer selected from the group consisting of nylon 6/66/12, nylon 6/69/6I, nylon 66/69/6I, and nylon 66/610/MXD6.

119. A polymeric film comprising a first layer made with a composition of claim 113.

120. A polymeric film comprising a first layer made with a composition of claim 114.

121. A polymeric film comprising a first layer made with a composition of claim 115.

122. A polymeric film comprising a first layer made with a composition of claim 116.

123. A polymeric film comprising a first layer made with a composition of claim 117.

124. A polymeric film comprising a first layer made with a composition of claim 118.

125. A polymeric film as in claim 119, said polymeric film having a shrink capacity of at least 40 percent in at least one of a machine direction and a transverse direction, when exposed to 90 degrees C. for 2 seconds.

126. A polymeric film as in claim 119, said polymeric film having a shrink capacity of at least 50 percent in at least one of a machine direction and a transverse direction, when exposed to 90 degrees C. for 2 seconds.

127. A polymeric film as in claim 121, said polymeric film having a shrink capacity of at least 50 percent in at least one of a machine direction and a transverse direction, when exposed to 90 degrees C. for 2 seconds.

128. A polymeric film as in claim 124, said polymeric film having a shrink capacity of at least 50 percent in at least one of a machine direction and a transverse direction, when exposed to 90 degrees C. for 2 seconds.

129. A polymeric film as in claim 126, further comprising a second ethylene vinyl alcohol-based layer in surface-to-surface contact with said first layer, optionally through an adhesive layer.

130. A polymeric film as in claim 127, further comprising a second ethylene vinyl alcohol-based layer in surface-to-surface contact with said first layer, optionally through an adhesive layer.

131. A polymeric film as in claim 128, further comprising a second ethylene vinyl alcohol-based layer in surface-to-surface contact with said first layer, optionally through an adhesive layer.

132. A composition of matter, comprising:
(a) 40 percent by weight to 98 percent by weight ethylene vinyl alcohol copolymer; and
(b) 60 percent by weight to 2 percent by weight of a semi-crystalline nylon composition, said semi-crystalline nylon composition comprising
(i) as a first semi-crystalline nylon component, an effective amount of nylon 6/69 and/or nylon 6/12 and/or nylon terpolymer, each having melting temperature of less than 170 degrees C., and
(ii) a second semi-crystalline nylon component which is distinguished by at least one physical property from said first semi-crystalline nylon component, in an effective amount, up to 80 percent by weight of said semi-crystalline nylon composition.

133. A composition as in claim 132 wherein said distinguishing property is melting temperature, and wherein the melting temperature of said second semi-crystalline nylon component is at least 10 degrees C. greater than the melting temperature of said first semi-crystalline nylon component.

134. A composition of matter as in claim 132 wherein
said ethylene vinyl alcohol copolymer is present in an amount of 60 percent by weight to 90 percent by weight of said composition, and
said semi-crystalline nylon composition is present in an amount of 40 percent by weight to 10 percent by weight of said composition.

135. A composition of matter as in claim 132 wherein
said ethylene vinyl alcohol copolymer is present in an amount of about 60 percent by weight to about 70 percent by weight of said composition, and
said semi-crystalline nylon composition is present in an amount of about 40 percent by weight to about 30 percent by weight of said composition.

136. A composition of matter as in claim 132 wherein at least 50 percent by weight of said semi-crystalline nylon composition is nylon 6/69.

137. A composition of matter as in claim 133 wherein at least 50 percent by weight of said semicrystalline nylon composition is nylon 6/69.

138. A composition of matter as in claim 132 wherein at least 50 percent by weight of said ethylene vinyl alcohol copolymer is a stretchable grade ethylene vinyl alcohol copolymer.

139. A composition of matter as in claim 133 wherein at least 50 percent by weight of said ethylene vinyl alcohol copolymer is a stretchable grade ethylene vinyl alcohol copolymer.

140. An extruded polymeric film made with a composition of claim 132.

141. An extruded polymeric film made with a composition of claim 133.

142. An extruded polymeric film made with a composition of claim 134.

143. An extruded polymeric film made with a composition of claim 136.

144. An extruded polymeric film made with a composition of claim 137.

145. An extruded polymeric film made with a composition of claim 138.

146. An extruded polymeric film made with a composition of claim 139.

147. An extruded polymeric film as in claim 140 wherein said semi-crystalline nylon composition is present in sufficient capacity to enable said extruded polymeric film to be biaxially oriented, and to thereby have an overall shrink capacity of at least 28 percent and up to about 55 percent in at least one of a machine direction and a transverse direction, when exposed to 90 degrees C. for 2 seconds.

148. An extruded polymeric film as in claim 141 wherein said semi-crystalline nylon composition is present in sufficient capacity to enable said extruded polymeric film to be biaxially oriented, and to thereby have an overall shrink capacity of at least 28 percent and up to about 55 percent in at least one of a machine direction and a transverse direction, when exposed to 90 degrees C. for 2 seconds.

149. An extruded polymeric film as in claim 144 wherein said semi-crystalline nylon composition is present in sufficient capacity to enable said extruded polymeric film to be biaxially oriented, and to thereby have an overall shrink capacity of at least 28 percent and up to about 55 percent in at least one of a machine direction and a transverse direction, when exposed to 90 degrees C. for 2 seconds.

150. An extruded polymeric film as in claim 146 wherein said semi-crystalline nylon composition is present in sufficient capacity to enable said extruded polymeric film to be biaxially oriented, and to thereby have an overall shrink capacity of at least 28 percent and up to about 55 percent in at least one of a machine direction and a transverse direction, when exposed to 90 degrees C. for 2 seconds.

151. An extruded polymeric film as in claim 147 wherein said ethylene vinyl alcohol copolymer is a stretchable grade ethylene vinyl alcohol copolymer.

152. An extruded polymeric film as in claim 149 wherein said ethylene vinyl alcohol copolymer is a stretchable grade ethylene vinyl alcohol copolymer.

153. An extruded polymeric film made with a composition of claim 138 as a first layer, said extruded polymeric film further comprising second and third olefin-based layers on opposing sides of said ethylene vinyl alcohol copolymer layer.

154. An extruded polymeric film as in claim 153, further comprising a fourth tie layer between said first and second layers, and a fifth tie layer between said first and third layers.

155. An extruded polymeric film as in claim 153, said film being biaxially stretched and having a shrink capacity of at least 28 percent in at least one of a machine direction and a transverse direction when exposed to 90 degrees C. for 2 seconds.

156. An extruded polymeric film as in claim 155 wherein said ethylene vinyl alcohol copolymer is present in said first layer in an amount of about 60 percent by weight to about 90 percent by weight, and wherein said semi-crystalline nylon composition is present in an amount of about 40 percent by weight to about 10 percent by weight.

157. An extruded polymeric film as in claim 154, further comprising a sixth layer and a seventh layer, said fourth layer being disposed between said first layer and said sixth layer, said fifth layer being disposed between said first layer and said seventh layer.

158. An extruded polymeric film as in claim 157, said film being biaxially stretched and having a shrink capacity of at least 28 percent in at least one of a machine direction and a transverse direction when exposed to 90 degrees C. for 2 seconds.

159. An extruded polymeric film as in claim 158 wherein said ethylene vinyl alcohol copolymer is present in said first layer in an amount of about 60 percent by weight to about 80 percent by weight, and said semi-crystalline nylon composition is present in an amount of about 40 percent by weight to about 20 percent by weight.

160. An extruded polymeric film as in claim 153 wherein said semi-crystalline nylon composition comprises an effective amount of nylon 6/69 and/or nylon 6/12 having a melting temperature of less than 145 degrees C.

161. A multiple layer polymeric film, comprising;\
(a) a first nylon-based layer;
(b) a second nylon-based layer; and
(c) a third ethylene vinyl alcohol copolymer-based layer comprising ethylene vinyl alcohol copolymer,
wherein at least one of the nylon-based layers comprises
(i) as a first component, about 10 percent by weight to about 65 percent by weight amorphous nylon,
(ii) as a second component, about 5 percent by weight to about 50 percent by weight of a relatively lower melting temperature semi-crystalline nylon composition having a melting temperature of less than 170 degrees C., and
(iii) as a third component, about 10 percent by weight to about 85 percent by weight of a relatively higher melting temperature semi-crystalline nylon composition, having an effective melting temperature of at least 145 degrees C., and at least 10 degrees C. greater than the melting temperature of said second component,
and wherein a weight ratio of the third component to the second component is 4.5/1 to about 17/1.

162. A multiple layer polymeric film as in claim 161 wherein the weight ratio of the third component to the second component is about 5/1 to about 17/1.

163. A multiple layer polymeric film as in claim 161 wherein at least one of said nylon-based layers comprises about 10 percent by weight to about 40 percent by weight of said amorphous nylon, about 5 percent by weight to about 35 percent by weight of said relatively lower melting temperature nylon, and about 55 percent by weight to about 85 percent by weight of said relatively higher melting temperature nylon.

164. A multiple layer polymeric film as in claim 161 wherein at least one of said nylon-based layers comprises about 15 percent by weight to about 40 percent by weight of said amorphous nylon, about 5 percent by weight to about 35 percent by weight of said relatively lower melting temperature nylon, and about 60 percent by weight to about 80 percent by weight of said relatively higher melting temperature nylon.

165. A multiple layer polymeric film as in claim 161 wherein said second relatively lower melting temperature nylon component comprises nylon 6/69 and/or nylon 6/12.

166. A multiple layer polymeric film as in claim 162 wherein said second relatively lower melting temperature nylon component comprises nylon 6/69 and/or nylon 6/12.

167. A multiple layer polymeric film as in claim 161 wherein stretchable grade ethylene vinyl alcohol copolymer defines at least 50 percent by weight of said third layer.

168. A multiple layer polymeric film as in claim 165 wherein stretchable grade ethylene vinyl alcohol copolymer defines at least 50 percent by weight of said third layer.

169. A multiple layer polymeric film as in claim 161, said multiple layer polymeric film further comprising a fourth outer layer defining a first outer surface of said polymeric film, and a fifth outer layer defining a second opposing outer surface of said film, wherein each of said first, second, and third layers is disposed between said fourth and fifth layers.
